(19) United States
(12) Patent Application Publication
(10) Pub. No.: US 2019/0134440 A1
(43) Pub. Date: May 9, 2019

(54) AERIAL FLOWABLE MATERIAL DELIVERY TRAILER

(71) Applicant: Aerial Tool Corporation, Norval (CA)

(72) Inventor: David Carter, Norval (CA)

(73) Assignee: Aerial Tool Corporation, Norval (CA)

(21) Appl. No.: 16/127,715

(22) Filed: Sep. 11, 2018

Related U.S. Application Data
(60) Provisional application No. 62/545,847, filed on Aug. 15, 2017.

(51) Int. Cl. A62C 27/00; A62C 31/22

(52) U.S. Cl. CPC A62C 27/00; A62C 31/22

(57) ABSTRACT

A flowable material delivery trailer is equipped to deliver flowable material (e.g. water, inert gas or other fluid, or flowable solid), preferably at a high pressure and a low flow rate, particularly in hazardous situations, for example in firefighting and in washing difficult to access areas or things (e.g. high voltage transmission towers, transformers on high voltage power lines, insulators on high voltage power lines, signs, street lights and other elevated surfaces). The trailer may comprise a plurality of detachable nozzles, which may be operated independently and simultaneously. The trailer is operable by a single operator under a variety of environmental conditions, and is capable of effectively managing flows to conserve flowable material during operation.

### CROSS-REFERENCE TO RELATED APPLICATIONS

This application claims the benefit of U.S. Provisional Patent Application Ser. No. 62/545,847 filed Aug. 15, 2017, the entire contents of which is herein incorporated by reference.

### FIELD

This application relates to a transportable apparatus and a method for delivering flowable material, for example a fluid and/or a flowable solid, especially for delivering the flowable material in hazardous situations.

### BACKGROUND

In hazardous situations, for example firefighting and washing of high voltage transmission towers or transformers and insulators on high voltage power lines, the capability to remotely and safely deliver pressurized water or other fluids is desirable. In firefighting, a variety of vehicle-mounted booms having water spray attachments have been proposed. In washing of transformers and insulators on electricity transmission towers, a helicopter outfitted with a power washer is generally used. Existing apparatuses suffer from one or more disadvantages including: high cost, especially in connection with booms mounted on the prime mover (e.g. fire trucks); lack of degrees of freedom for properly positioning the water sprayer; and, lack of flexibility for a single apparatus to meet the requirements of different situations.

In the context of firefighting, there are three basic requirements for a fire to sustain burning, which are a fuel, an oxidizing agent (e.g. oxygen) and a source of heat. Once a fire starts, burning of the fuel provides heat for further burning of the fuel, which left unchecked will continue to burn until all available fuel is consumed. Removing any one of these three requirements would extinguish the fire.

In recent years, a new firefighting tactic called SLICERS has been developed to help first responders to more effectively fight a fire in the early stages when the ability to quickly contain and extinguish a fire is most likely to result in saving of lives and property. The SLICERS method highlights the need to consider the importance of an awareness of flow path and cooling during fire attack. In doing so, the SLICERS method involves the following sequential activities: Size up all scenes; Locate the fire; Identify & control the flow path (if possible); Cool the heated space from a safe location; Extinguish the fire; Rescue and Salvage, which are actions of opportunity that may occur at any time.

The main problem faced by firefighters using the SLICERS method is having the correct equipment to be able to undertake all of the activities in a fast and efficient manner. Current equipment (e.g. fire trucks) are insufficient for the myriad of possibilities that a firefighter faces when arriving on the scene of a fire. Further, existing firefighting technologies (e.g. fire trucks) also suffer from requiring many people to operate and high water volume requirements. Current firefighting equipment typically provides fluid fire suppressant (e.g. water) at a volume flow rate of about 300 gallons (about 1140 liters) per minute under a pressure of about 100 psi (about 700 kPa), without any way of monitoring the fire in a structure for fire suppressant conservation.

There remains a need for an improved transportable apparatus for delivering flowable material, for example a fluid, which can preferably meet requirements of the SLICERS firefighting method while permitting monitoring of a fire in a burning structure for better decisions regarding conservation of the flowable material.

### SUMMARY

The present invention provides a flowable material delivery trailer operable by a single operator and equipped to deliver flowable material in a situation where delivery of the flowable material is required, preferably at a high pressure and a low flow rate. The present invention is particularly suitable for flowable material delivery in hazardous situations, for example in firefighting and in washing difficult to access areas or things (e.g. high voltage transmission towers, transformers on high voltage power lines, insulators on high voltage power lines, signs, street lights and other elevated surfaces). The trailer is self-contained and portable, providing all necessary equipment to deliver flowable material for a desired task. As such, the trailer is particularly useful in remote or rural areas where access to on-location external infrastructure is not possible. For example, the ability to fight a fire in a rural building absent fire hydrants and with as few as one volunteer firefighter requires a complete and portable unit that is operable by a single operator under a variety of environmental conditions. The flowable material delivery trailer may further provide the ability to implement the SLICERS firefighting method with a single portable piece of equipment. The present invention provides such a capability.

The trailer may comprise one or more of: at least one frame; plurality of wheels mounted on the at least one frame for transporting the trailer between locations; plurality of outriggers mounted on the at least one frame, the outriggers moveable between a raised ground-disengaging position to permit the trailer to be transported on the plurality of wheels and a lowered ground-engaging position to stabilize the trailer on the ground and prevent the trailer from being transported on the plurality of wheels; a hitch for attaching the trailer to a towing vehicle; a flowable material reservoir for containing a flowable material to be delivered; an articulated boom rotatably mounted on the at least one frame proximate a first end of the boom; an end effector mounted on the boom proximate a second end of the boom, the end effector comprising a flowable material delivery nozzle in material flow communication with the reservoir, the delivery nozzle operable to deliver the flowable material; at least one pump operably connected to the reservoir and the nozzle for pumping the flowable material from the reservoir to the nozzle; a control system configured to operate the at least one pump, outriggers, hitch, articulated boom and/or end effector, the control system comprising a logic circuit configured to compile information for use by a single operator; and, at least one power source operably connected to the at least one pump, outriggers, hitch, articulated boom, end effector and/or control system for powering the at least one pump, outriggers, articulated boom, end effector and/or control system.

The trailer may comprise at least one frame. There may be one frame or a plurality of frames connected together. The at least one frame preferably comprises generally longitudinal and transverse frame elements connected together to provide a sturdy support on which the equipment may be mounted.

The plurality of wheels may be mounted on the at least one frame and configured for transporting the trailer between locations. The plurality of wheels may be rotatably mounted on one or more axles, and the one or more axles mounted on the frame. The number of wheels and axles may depend on the overall weight of the equipment on the frame, the towing capacity of the towing vehicle and other considerations. Tandem axle trailers may be preferred when better stability and ease of towing are desired.

Instead of or in addition to wheels, the trailer may be provided with tracks, sliders (e.g. skis), pontoons, boat hulls or other travel-surface-engaging elements to facilitate travel over various kinds of terrain. Travel-surface-engaging elements may be self-propelled, if desired, receiving power from any suitable source, for example a motor (e.g. electric, hydraulic and/or internal combustion motors). The towing vehicle may be any desired vehicle suitable for the terrain, for example a truck, a tractor, a snow cat, a motor boat and the like. The trailer may be further equipped with brakes, for example surge or electric brakes, to assist in stopping the trailer. The type of brakes most suitable for a particular trailer may depend on the type of motion that the trailer experiences while being towed, the type of travel-surface-engaging elements on which the trailer rides and the type of towing vehicle. For example, for a tractor-towed trailer in a park-like setting where the trailer has non-powered tracks, surge brakes may be more appropriate.

The plurality of outriggers may be mounted on the at least one frame. The outriggers may be moveable between a raised ground-disengaging position to permit the trailer to be transported on the plurality of wheels and a lowered ground-engaging position to stabilize the trailer on the ground and prevent the trailer from being transported on the plurality of wheels. Any suitable number of outriggers may be used. Preferably, from 4 to 6 outriggers are used. At least some of the outriggers are preferably deployed on both sides of the trailer. One or more of the outriggers may be deployed at the front and/or rear of the trailer. The outriggers may be equipped with actuators (e.g. hydraulic cylinders, electric linear actuators, springs and the like or any combination thereof) to enable lowering and raising of the outriggers. The outriggers are generally lowered into the ground-engaging position when fluid delivery is to commence to provide relatively stable and immovable support for the trailer on the ground. When the trailer is to be moved, the actuators may be used to raise the outriggers so that the trailer is supported on the ground by the wheels for transportation.

One or more of the outriggers, preferably all of the outriggers, may further be adjustable in length. The length of the outriggers may be adjustable between a fully retracted position and a fully extended position. Further, length adjustment of the outriggers may be effected in one or more spatial directions. For example, the outriggers may be length adjustable in both a horizontal direction parallel to the ground and a vertical direction perpendicular to the ground. Such multi-directional length adjustment may improve the ability of the outriggers to support the trailer on uneven surfaces. Length adjustability in any of the directions may be accomplished in any suitable manner, for example with suitably oriented telescoping leg sections coupled to actuators (e.g. hydraulic cylinders).

Confirmation of the positions of the outriggers (e.g. retracted, extended or in-between) may be determined by sensors, for example inductive proximity sensors, which send signals to a controller on the trailer. Length adjustability of the outriggers may be configured to operate in tandem. For example, the outriggers on one side of the trailer may only extend and retract in unison, separately from extension and retraction of the outriggers on the other side of the trailer, which may also extend and retract in unison with each other. The positions of the outriggers are preferably determined prior to lowering the outriggers to ground-engaging positions. Once the outriggers are on the ground, length adjustment may not be allowed. The outriggers may also be equipped with a levelling functionality, desirably an auto-levelling functionality. Levelling functionality may operate regardless of the length adjustment position of the outriggers. All operations of the outriggers may be controlled by a controller on the trailer, and the controller may be programmed with suitable logic to automatically control the operation of the outriggers. Adjustable outriggers enable the trailer to be utilized in a wider range of work applications, therefore giving the user more flexibility when setting up the trailer.

Length adjustability of the outriggers makes it desirable to apply certain height and reach limitations on the trailer to ensure stability of the trailer in all setup configurations. The particular limitations to be applied may depend upon the combination of extended and retracted (paired) outriggers, as illustrated in the following examples. In a Normal Position (all outriggers extended), no limitations are applied to height and reach capabilities of the trailer. In a Compact Position (all outriggers retracted), height and reach capabilities are reduced to ensure stability of the trailer. In a Short Left-Side (SLS) Position (left-side outriggers retracted and right-side outriggers extended), the trailer is allowed to operate within a 180° operating arc on the right-side of the trailer only and height and reach limitations are also applied. In a Short Right-Side (SRS) Position (right-side outriggers retracted and left-side outriggers extended), the trailer is allowed to operate within a 180° operating arc on the left-side of the trailer only and height and reach limitations are also applied.

The hitch permits attaching the trailer to the towing vehicle. Because the trailer may be relatively lightweight and self-contained for the desired material delivery task, any towing vehicle with sufficient towing capacity may be used to tow the trailer. Large and/or specialized vehicles (e.g. fire trucks) are not needed, reducing both capital and operating costs and providing a more versatile approach to material delivery needs using a single apparatus. The hitch may be configured to permit quick attachment and detachment from the towing vehicle.

The reservoir may be integrated as part of the frame, mounted on the at least one frame or mounted on an extra trailer hitched to the trailer. The reservoir contains flowable material to be delivered. The reservoir may comprise a tank, cistern, hopper or any other storage vessel adapted for containing the desired flowable material. The trailer may comprise one or more than one reservoir. More than one kind of flowable material may be stored in the reservoirs. Because the trailer may be lightweight in comparison to prior art apparatuses, the reservoir may be correspondingly larger to hold more flowable material thereby increasing overall weight of the trailer without unduly affecting the capacity of the towing vehicle to tow the trailer. Thus, more flowable material can be delivered in one delivery using the present invention than can be delivered using apparatuses of the prior art.

The flowable material may be a fluid, a flowable solid or a mixture thereof. The flowable solid may be a powder or other particulate material. The flowable material may be a mixture of solid and liquid (e.g. a suspension) or a mixture of solid and gas (e.g. a foam). The fluid may be a liquid, an inert gas or a combination thereof (e.g. an aerosol or a foam). The flowable material is preferably a water-based liquid, for example water (e.g. deionized water), chemical fire suppressants (e.g. expansion foams), cleaning solutions and the like. The inert gas, for example nitrogen, argon, carbon dioxide, a fluorinated hydrocarbon (e.g. bromotrifluoromethane (Halon™)), tear gas or the like, may be co-delivered with a liquid or flowable solid, delivered instead of a liquid or flowable solid, or delivered in series with a liquid or flowable solid. The flowable material may be stored pressurized or unpressurized in the reservoir. Preferably, liquids are stored unpressurized while gases are stored pressurized and flowable solids are stored under pressurized gas to assist in delivering the flowable solid.

In one embodiment, especially useful for applications in washing high voltage transmission towers, transformers on high voltage power lines and/or insulators on high voltage power lines, the fluid may be water and the trailer may comprise a water deionization system. Water may be deionized and returned to the reservoir to be used later and/or the water deionization system may be configured to deionize water being pumped from the reservoir on an “on-demand” basis before being delivered out the nozzle. Preferably, an “on demand” deionization system is utilized because it is generally difficult to preserve deionized water over an extended period of time. The deionization system is preferably mounted between the reservoir and the nozzle in fluid communication with both the reservoir and the nozzle. Resistivity of the deionized water may be monitored, for example by the control system, in order to determine when the system needs to be switched over to a new deionizing column. Switching the deionization system to a new column and back-flushing the used column may be accomplished automatically by the control system.

The articulated boom may be rotatably mounted on the at least one frame proximate a first end of the boom. A boom swivel mounted on the at least one frame and connected to the boom proximate the first end of the boom may permit rotation of the boom around a vertical axis with respect to the ground. The boom swivel may be hydraulically, electrically or mechanically operated, preferably hydraulically operated. In one embodiment, the boom swivel may be located within the reservoir and a flowable material supply conduit in material flow communication with the reservoir and the nozzle may pass through the boom swivel so that the swivel may rotate about the vertical axis while permitting flowable material to flow from the reservoir to the nozzle without entangling hoses extending from the flowable material supply conduit to the end effector.

The boom may further comprise a plurality of arms connected at joints about which the arms are rotatable. At least one arm may be extensible. In one embodiment, at least a portion of the boom may be electrically isolated, for example the at least a portion of the boom may be made of a non-conductive material (e.g. fiberglass, polymer composite, etc.). In one embodiment, one or more of the arms, or one or more portions of one or more of the arms, may be electrically isolated. In another embodiment, at least a portion of the boom may comprise a fire-resistant material (e.g. steel, aluminum composite, etc.), which is particularly useful in firefighting applications.

The end effector may be mounted on the boom proximate a second end of the boom. The end effector may comprise the delivery nozzle in flow communication with the reservoir. The delivery nozzle may be operable to deliver the flowable material. The end effector may provide for multiple degrees of freedom for movement of the nozzle with respect to the ground. For example, the nozzle may be movable up and down in a vertical plane with respect to the ground, the nozzle may be moveable side to side in a horizontal plane with respect to the ground, the nozzle may be rotatable about a longitudinal axis between front and rear of the end effector, the nozzle may be rotatable about a transverse vertical axis and/or the nozzle may be rotatable about a transverse horizontal axis. In a preferred embodiment, the nozzle may be movable in all of the above.

The end effector may further comprise an end effector swivel between the nozzle and the boom, the end effector swivel rotatable continuously through 360° to rotate the nozzle continuously through 360°. In one embodiment, the end effector swivel may comprise an internal hydraulic fluid conduit through which hydraulic fluid may be transported from a hydraulic fluid supply to the nozzle to hydraulically operate components associated with the nozzle. In one embodiment, the end effector swivel may comprise a set of slew gears to permit the end effector to move vertically and horizontally in space and to rotate about the longitudinal axis of the end effector.

The end effector may comprise a hydraulically powered high gear ratio actuator configured to rotate the head about the longitudinal axis. The end effector may comprise a hydraulically powered high gear ratio actuator configured to move the head side to side. The end effector may comprise a hydraulically powered high gear ratio actuator configured to move the head up and down. The actuators may lock in position during a hydraulic failure. One or more of the hydraulically powered high gear ratio actuators that rotate the head and move the head side to side and up and down may comprise slew drives drivingly connected to a hydraulic motor. A manifold of valves may be employed to control hydraulic fluid flow to the end effector. The valves may comprise solenoids, for example center-spool solenoids. One or more of the solenoids may comprise a spring return, especially the solenoid or solenoids that control fluid flow to the end effector.

In one embodiment, the end effector swivel may comprise a rotatable core comprising the hydraulic fluid conduit, a ring mounted on the core rotating with the core, and a non-rotatable housing disposed around the core. The hydraulic fluid conduit may be in fluid communication with a first fluid port through the ring and a second fluid port through the housing. The hydraulic fluid conduit may transport hydraulic fluid inside the swivel between the first and second fluid ports. The fluid conduit may comprise a plurality of hydraulic fluid conduits. The first fluid port may comprise a first plurality of fluid ports. The second fluid port may comprise a second plurality of fluid ports. Each of the plurality of hydraulic fluid conduits may fluidly connect one of the first fluid ports to one of the second fluid ports. The first fluid port may be connected to the nozzle by one or more first hydraulic lines. The second fluid port may be connected to the hydraulic fluid reservoir by one or more second hydraulic lines. Rotation of the end effector swivel continuously through 360° may not wind any of the hydraulic lines around the end effector. Thus, the end effector may help reduce hydraulic line failure by reducing or eliminating failure resulting from hydraulic lines catching on obstacles or twisting during full 360° rotation of the end effector.

The end effector together with the articulated boom offer greater freedom of movement for the nozzle than has been capable hitherto, thereby permitting a wider range of options for properly placing the nozzle to perform a task.

The nozzle may be configured to deliver flowable material in a manner suitable for the desired task. In a particularly advantageous embodiment, the flowable material is delivered through the nozzle under high pressure at a relatively low flow rate in comparison to other delivery apparatuses. High pressure, relatively low flow rate delivery maximizes effectiveness of the flowable material at the desired task while preserving flowable material thereby requiring less flowable material to complete the task, extending flowable material delivery time, requiring less down time to replenish flowable material in the reservoir if needed, and reducing overall weight thereby permitting the use of a trailer rather than a large truck or other vehicle. Further, sprayed flowable material at high pressure and relatively low flow rate both cools a fire and deprives the fire of oxygen for more effective firefighting performance. The flowable material pressure is preferably greater than about 500 psi. More preferably, the pressure is in a range of about 500-1500 psi, or about 700-1400 psi, or about 1000-1300 psi, for example about 1200 psi. The flow rate is preferably in a range of about 5-100 gallons per minute (gal/min), or about 10-50 gal/min, or about 15-30 gal/min.

The at least one pump may be operably connected to the reservoir and the nozzle for pumping the flowable material from the reservoir to the nozzle. The at least one pump preferably pumps the flowable material at high pressure at a relatively low flow rate. The at least one pump is preferably designed to pump a liquid, particularly a water-based liquid. For delivery of a gas to the nozzle, the gas is preferably stored under pressure in the reservoir, thereby not requiring a pump to deliver the gas to the nozzle. For delivery of a flowable solid to the nozzle, the solid is preferably stored with a pressurized gas in the reservoir, thereby not requiring a pump to deliver the flowable solid to the nozzle.

In firefighting applications, the nozzle may also be equipped with a piercing element to pierce structures without destroying overall structural integrity of the structure or creating overly large holes in the structure. As indicated above in connection with nozzle placement, the end effector together with the articulated boom offer greater freedom of movement for the piercing element than has been capable hitherto, thereby permitting a wider range of options for properly orienting the piercing element to pierce structures at desired locations, for example through a side wall rather than through a roof of a building envelope, airplane or the like.

The piercing element may be driven to penetrate a structure in any suitable manner, for example by movement of the boom, by mechanical springs, by pneumatic springs (e.g. hydraulic cylinders) or by hydraulic pressure of a firefighting fluid. Re-setting the piercing element after a piercing event may be accomplished in any suitable manner, for example manually, with the use of return springs (mechanical and/or pneumatic) or with the use of hydraulic pressure of the firefighting fluid. In one embodiment, the piercing element is driven through the structure by movement of the boom. In one embodiment, hydraulic pressure from fluid delivered through the nozzle may be used to drive a spring-loaded piercing element, the spring (mechanical or pneumatic) returning the piercing element to re-set position automatically once the fluid flow through the nozzle is switched off. The piercing element may be rotated to provide further penetrating power. Rotation of the piercing element may be accomplished in any suitable manner, for example with a motor (e.g. a screw motor). The nozzle and piercing element may be separate or integrated together into a single element.

The end effector may be configured to permit interchangeability of nozzles, so that a single apparatus may be utilized for multiple and disparate flowable material delivery applications. For example, the end effector may be equipped with a connector to permit releasable attachment of the nozzle to the rest of the end effector. In one embodiment, the nozzle may be releasably connected to the swivel proximate a distal face of the swivel. The connector may comprise, for example, screws, bolts, clamps, pins, adhesives or any combination thereof. Irrespective of the type of nozzle and its application, each nozzle may include the same type of end effector connector so that the remainder of the end effector does not need to be changed. In one embodiment, a nozzle connector and an end effector connector form a mated pair of connectors. The mated pair of connectors may comprise, for example, mated screw threads, one or more bolts in one or more bolt holes, bayonet connectors, pins in apertures, clamps and clamping regions, and the like.

The end effector may comprise one or more nozzles, for example 1, 2, 3, 4, 5, 6 or more nozzles. Any one or more of the one or more nozzles may be non-removably fixed to the end effector or detachable therefrom. Each nozzle may be deployable to participate in separate tasks simultaneously. Each nozzle may be supplied flowable material through the same or separate hoses. The use of separate hoses permits deploying one or more nozzles at different locations. The use of separate hoses also permits supplying different nozzles with different flowable material to perform different tasks. The hoses may be connected by valves to permit each nozzle to receive flowable material from any one or more of the reservoirs of the trailer. Individual hoses may be stored on hose reels mounted in any convenient place on the trailer. The hose reel permits deploying a detachable nozzle and then moving the boom to deploy another nozzle without disturbing the position of the detached nozzle, while at the same time maintaining material flow communication between the detached nozzle and the reservoir.

The control system may be configured to operate the at least one pump, outriggers, hitch, articulated boom, end effector and/or other components of the trailer. The control system may comprise one or more controllers configured to permit control of operations of the trailer. At least one of the one or more controllers may comprise a remote control configured to permit an operator to control operation of the trailer from a safe location away from the trailer. At least one of the one or more controllers may comprise an emergency stop functionality.

The trailer may further comprise a data transmitter (e.g. wired or wireless) in electronic communication with one or more sensors on the trailer. The data transmitter may transmit signals to a remote or local data collection device. The one or more sensors may comprise one or more of a global positioning system, a timer, a wind speed gauge, a temperature gauge, an altimeter, a sound detector and an imaging system. In one embodiment, the imaging system may comprise one or more thermal imaging cameras oriented to capture images of the end effector, especially the nozzle, and/or surrounding environment. The trailer may further comprise one or more lights that illuminate the end effector, especially the nozzle.

The control system may comprise a logic circuit, for example a programmable logic circuit, with operating logic configured to automatically control one or more aspects of operation of the trailer. For example, a logic circuit may be configured to simultaneously and automatically unlock the boom, unlock and lower the outriggers and detach the hitch from the towing vehicle when the power source to operate the trailer is switched on, or upon activation of a single control switch. Simultaneous and automatic operation in this manner permits raising the boom very quickly, for example within 30 seconds of arriving at a location, which is particularly useful in firefighting application where time is of the essence. The operating logic preferably compiles all information for consideration and use by a single operator. The logic circuit is preferably configured to synthesize multiple sensor inputs into an information package on which a firefighting decision may be made.

The control system, sensors and various components of the trailer may be in electronic communication with each other either wirelessly or through communication lines (e.g. wires, cables and the like).

For use especially in firefighting applications, one or more heat sensors may be provided on the boom to identify hot spots in a structure. At least one of the one or more heat sensors is preferably located proximate a distal end of the boom to more efficiently provide an aerial infrared survey to locate hot spots more quickly (e.g. within seconds) compared to ground-based surveys typically performed at present, which take several minutes. More quickly identifying hot spots saves valuable time in directing firefighting material at appropriate locations in a burning structure.

Further, the nozzle may be equipped with one or more sensors, for example a heat sensor (e.g. a thermocouple), a sound sensor and/or an imaging device (e.g. a camera) to provide information to the control system and operator about local conditions immediately around the nozzle. Sensors associated with the nozzle are particularly useful for firefighting when the nozzle is equipped with a piercing element and deployed inside a structure. From the outside of a burning structure, it is typically impossible to determine the conditions inside the burning structure, but one or more sensors associated with the nozzle in the structure can provide valuable information about the status of the fire in the immediate vicinity of the nozzle. Such information can permit the control system or operator to switch off fluid supply to a particular nozzle if the fire in the nozzle's locale has been extinguished. If the fire in the locale restarts, the one or more sensors can inform the control system or operator to restart fluid supply to the nozzle. Such information is important for flowable material management and conservation, especially when the burning structure is in a remote location. The fluid reservoir has a finite capacity and, if there is no other convenient source of flowable material, conservation of flowable material in the reservoir is important. The one or more sensors associated with the nozzles may be in electronic communication with the control system through communication lines that run inside the hoses.

The power source may be operably connected to the at least one pump, outriggers, hitch, articulated boom, end effector and/or control system for powering the at least one pump, outriggers, articulated boom, end effector and/or control system. The power source may comprise, for example, one or more engines (e.g. diesel, gasoline, etc.), generators, hydraulic motors and the like. The power source may be adapted to provide electricity to power the various pieces of equipment. One or more hydraulic pumps may be used to power hydraulic equipment, for example the end effector and hydraulic cylinders on the outriggers. The trailer may also be equipped with a redundant drive system for at least any hydraulic pumps and the at least one fluid pump allowing the pumps to connect to a power-take-off shaft coupled to the towing vehicle.

In one embodiment, a flowable material delivery trailer comprises: at least one frame; an articulated boom rotatably mounted on the at least one frame proximate a first end of the boom; at least one flowable material reservoir mounted on the at least one frame for containing at least one flowable material to be delivered; a plurality of detachable flowable material delivery nozzles releasably mounted on the boom proximate a second end of the boom; and, a plurality of flowable material lines in flow communication with the at least one flowable material reservoir and the detachable flowable material delivery nozzles, the detachable flowable material delivery nozzles operable independently and simultaneously to deliver the at least one flowable material.

In one embodiment, a flowable material delivery trailer comprises: at least one frame; a plurality of wheels mounted on the at least one frame for transporting the trailer between locations; a plurality of outriggers mounted on the at least one frame, the outriggers moveable between a raised ground-disengaging position to permit the trailer to be transported on the plurality of wheels and a lowered ground-engaging position to stabilize the trailer on the ground and prevent the trailer from being transported on the plurality of wheels; hitch for attaching the trailer to a towing vehicle; a flowable material reservoir mounted on the at least one frame for containing a flowable material to be delivered; an articulated boom rotatably mounted on the at least one frame proximate a first end of the boom; a hydraulically operated end effector mounted on the boom proximate a second end of the boom, the end effector comprising a flowable material delivery nozzle in flow communication with the flowable material reservoir, the flowable material delivery nozzle operable to deliver the flowable material at a low flow rate and high pressure; at least one pump operably connected to the flowable material reservoir and the nozzle for pumping the flowable material from the reservoir to the nozzle; a control system configured to operate the at least one fluid pump, outriggers, hitch, articulated boom and/or end effector; and, at least one power source operably connected to the at least one pump, outriggers, hitch, articulated boom, end effector and/or control system for powering the pump, outriggers, articulated boom, end effector and/or control system.

In one embodiment, there is provided a method of conserving flowable firefighting material while fighting a fire in a structure, the method comprising: determining a first location of a first hot spot inside a burning structure indicative of a fire burning at the first location; deploying a first spray nozzle in or proximate to the first hot spot by penetrating the structure with the first nozzle so that at least a portion of the first nozzle is inside the structure, and switching on a flow of a first flowable firefighting material to the first nozzle; sensing a first characteristic of the fire at the first hot spot with a first sensor configured to determine, based on the first characteristic, whether the fire still burns at the first hot spot, the first sensor situated at the portion of the first nozzle inside the structure; determining a second location of a second hot spot inside a burning structure indicative of a fire burning at the second location; deploying a second spray nozzle in or proximate to the second hot spot by penetrating the structure with the second nozzle so that at least a portion of the second nozzle is inside the structure, and switching on a flow of a second flowable firefighting material to the second nozzle; sensing a second characteristic of the fire at the second hot spot with a second sensor configured to determine, based on the second characteristic, whether the fire still burns at the second hot spot, the second sensor situated at the portion of the second nozzle inside the structure; switching off the flow of the first firefighting material to the first nozzle when the first sensor determines that the fire has stopped burning at the first location, or switching on the flow of the first firefighting material to the first nozzle when the first sensor determines that the fire has restarted burning at the first location; and, switching off the flow of the second firefighting material to the second nozzle when the second sensor determines that the fire has stopped burning at the second location, or switching off the flow of the second firefighting material to the second nozzle when the second sensor determines that the fire has restarted burning at the second location.

Overall, in comparison to similar prior art apparatuses, the trailer of the present invention is operable by one operator rather than many operators, is mobile, is self-contained, is faster to set up, is safer, is less expensive, provides greater freedom to properly place the nozzle to perform a task and/or provides the ability to perform a variety of different tasks using a single apparatus. In a firefighting operation, the ability to set up the trailer within 1 minute as opposed to 5 minutes or more for prior art apparatuses is a great advantage, especially since fires today burn hotter and more quickly due to the proliferation of burnable items in buildings of today. The trailer is also well suited for employing the SLICERS method of firefighting.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a schematic drawing of a first embodiment of a flowable material delivery trailer in accordance with the present invention in a stowed configuration.

FIG. 2 depicts a schematic drawing of the trailer of FIG. 1 in an operating configuration with a boom deployed in several different possible operational configurations illustrating a range of motion for the boom.

FIG. 3 depicts a schematic drawing of a side of an end effector at an end of the boom of the trailer in FIG. 1.

FIG. 4A depicts a schematic drawing of a nozzle designed for piercing a structure and delivering an aerosol of fluid in a firefighting operation.

FIG. 4B depicts a schematic drawing of a nozzle designed for providing a jet of fluid in a cleaning operation.

FIG. 4C depicts a schematic drawing of another embodiment of a nozzle designed for piercing a structure and delivering an aerosol of fluid in a firefighting operation.

FIG. 4D depicts a schematic drawing of yet another embodiment of a nozzle designed for piercing a structure and delivering an aerosol of fluid in a firefighting operation.

FIG. 5 depicts a block diagram of a control system for controlling operations of the trailer of FIG. 1.

FIG. 6A depicts a second embodiment of a flowable material delivery trailer in accordance with the present invention in a stowed configuration.

FIG. 6B depicts the trailer of FIG. 6A showing a fluid tank mounted within a frame of the trailer.

FIG. 7 depicts the trailer of FIG. 6A in an operating configuration with a boom deployed.

FIG. 8A depicts a third embodiment of a flowable material delivery trailer in accordance with the present invention in a stowed configuration.

FIG. 8B depicts a side view of the trailer of FIG. 8A with a housing cover removed.

FIG. 8C depicts the trailer of FIG. 8A in an operating configuration for fighting a fire in a building.

FIG. 8D depicts the trailer of FIG. 8C fighting the fire in the building.

FIG. 8E depicts the trailer of FIG. 8D during post-firefighting shut down.

FIG. 8F depicts a magnified view of an end effector attached to a distal end of a boom of the trailer of FIG. 8D.

FIG. 9A depicts the trailer of FIG. 8A partially cut-away and showing more detail of a rotatable housing.

FIG. 9B depicts a magnified view of the housing shown in FIG. 9A.

FIG. 10 depicts cut-away of the trailer around the housing of FIG. 9B showing further detail of a rotary swivel on which the housing is mounted.

FIG. 11 depicts a magnified view of hose reels mounted on the housing of FIG. 9B.

FIG. 12A depicts a hose guide attached to a boom of the trailer of FIG. 8A.

FIG. 12B depicts a magnified view of the hose guide of FIG. 12A.

FIG. 13A depicts details of the end effector of FIG. 8F mounted on the boom.

FIG. 13B depicts the end effector of FIG. 8F in an extended configuration mounted on the boom.

FIG. 13C depicts the end effector of FIG. 13A in a retracted configuration as the end effector swings through an arc.

FIG. 13D depicts the end effector of FIG. 13B in an extended configuration as the end effector continues to swing through the arc.

FIG. 14A depicts a perspective view of the end effector of FIG. 8F.

FIG. 14B depicts a top view of the end effector of FIG. 14A.

FIG. 14C depicts a perspective view of the end effector of FIG. 14A with all harpoon assemblies in stowed positions.

FIG. 14D depicts the end effector of FIG. 14C with one of the harpoon assemblies in an operating position.

FIG. 14E depicts a magnified view of the end effector of FIG. 14A showing internal features of the harpoon assemblies.

FIG. 15 depicts a side cross-sectional view of a harpoon assembly FIG. 16A depicts the harpoon assembly of FIG. 15 with a piercing lance attached.

FIG. 16B depicts the harpoon assembly of FIG. 16A with the piercing lance detached.

FIG. 17 depicts a schematic diagram illustrating fluid connections on the trailer of FIG. 8A.

FIG. 18 depicts a block diagram of a control system for controlling operations of the trailer of FIG. 8A.

### DETAILED DESCRIPTION

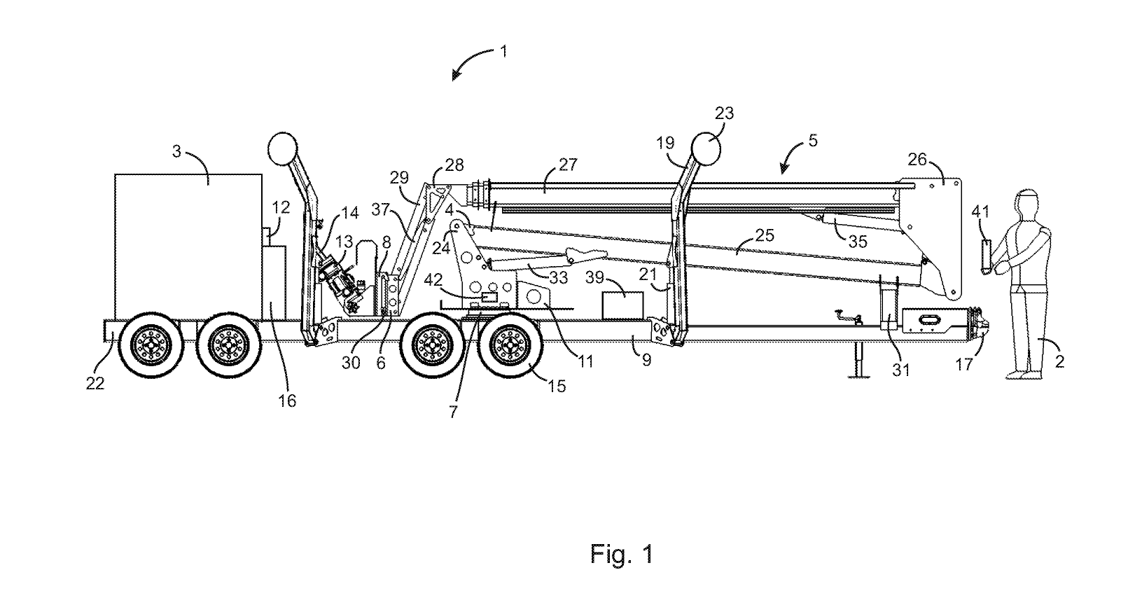

With reference to FIG. 1, a trailer 1 in accordance with a first embodiment of the present invention is shown in a stowed configuration. The trailer 1 comprises an articulated boom 5 rotatably mounted and supported on the trailer 1 via a rotatable mount 7 at a near end 4 of the boom 5, and an end effector 13 mounted at a far end 6 of the boom 5 via an end effector mount 8. The end effector 13 comprises a nozzle 14 as more fully described below. The nozzle 14 is in fluid communication with a fluid supply, for example water, fire suppressant or cleaning liquid, in a fluid tank 3 through a hose (not shown). A fluid pump 12 is configured to pump fluid from the fluid tank 3 through the hose to the nozzle 14 on the end effector 13. An on-demand water deionizer 16 provides the opportunity to deionize water for specialty cleaning operations. The fluid tank 3 and deionizer 16 are mounted on a wheeled extension 22 of a frame 9 of the trailer 1. The rotatable mount 7 is secured to the frame 9 of the trailer 1 and to a base 11 of the boom 5 at the near end 4 of the boom 5.

The rotatable mount 7 may be rotated by a hydraulically driven rotary manifold. The rotary manifold that rotates the rotatable mount 7 may comprise a fluid pickup (e.g. a pipe) extending therethrough and extending into the fluid tank 3. Fluid may be pumped out of the fluid tank 3 through the rotary manifold by way of the fluid pickup into a hose running a length of the boom 5. The rotary manifold may therefore be continuously driven through 360° while spraying fluid out the nozzle 14. Further, the fluid tank 3 may be equipped with an external feed line extending from the fluid tank 3 to an external fluid source, for example a pond, river, lake, hydrant and the like, to re-fill the fluid tank 3.

The trailer 1 rides on wheels 15 (only one labeled) and may be towed by a vehicle (not shown) by hitching the trailer 1 to the vehicle at hitch 17. When the trailer 1 is in use, the trailer 1 may be stabilized on a surface (e.g. the ground) by stabilizer legs 19 (only one labeled). In this embodiment four stabilizer legs 19 are present. The stabilizer legs 19 may be raised and lowered by any suitable mechanism, for example leg hydraulic cylinders 21 (only one labeled). FIG. 1 shows the stabilizer legs 19 in a stowed raised position with the feet 23 (only one labeled) off the ground. Lowering the stabilizer legs 19 causes the feet 23 to engage the ground and partially or fully lift the wheels 15 of the trailer 1 off the ground so that the trailer 1 cannot roll on the wheels 15.

The boom 5 comprises three arms 25, 27, 29. Arm 25 is pivotally connected to the base 11 at joint 24 and pivotally connected to arm 27 at joint 26. The arm 27 is pivotally connected to the arm 25 at joint 26 and pivotally connected to arm 29 at joint 28. The arm 29 is pivotally connected to the arm 27 at joint 28 and pivotally connected at joint 30 to the end effector mount 8. Pivoting of the arms 25, 27, 29 causes the boom 5 to unfold or refold. In the stowed position, the arm 25 may be secured to the trailer 1 with securing bracket 31 to ensure that the boom 5 does not move unduly during transport. The trailer 1 may comprise more than one securing bracket. The arms 25, 27, 29 may be pivoted by any suitable mechanism, for example arm hydraulic cylinders 33, 35, 37.

Hydraulic fluid reservoir 39 mounted on the trailer 1 supplies hydraulic fluid to all hydraulically driven components through a plurality of hydraulic lines (not shown). An operator 2 may remotely control operation of various components of the trailer 1 using a wireless remote control 41 or a controller 42 located on the trailer 1. When the trailer 1 is parked as shown in FIG. 1, a sensor (not shown) may be configured to activate a failsafe to prevent operation of the end effector 13. The failsafe may be configured to enable manual override in order to operate the end effector 13 for purposes of maintenance, testing, etc., if desired.

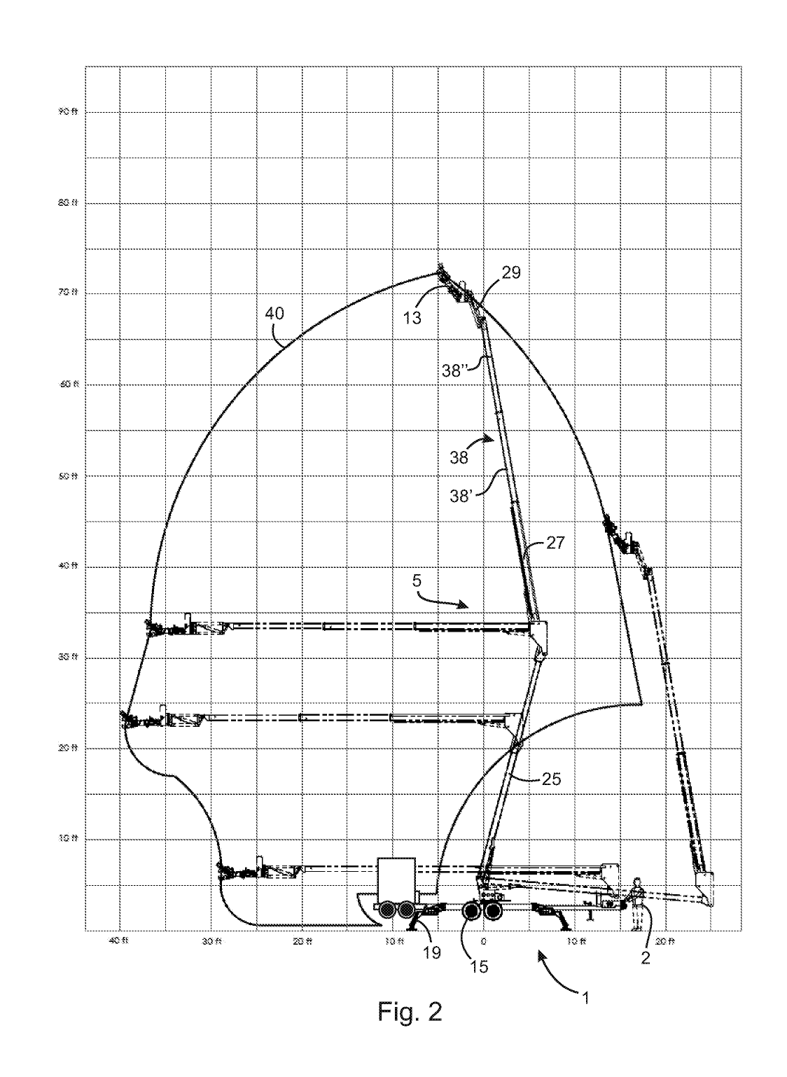

With reference to FIG. 2, the trailer 1 may be deployed in a wide variety of operational configurations, a few of which are illustrated in FIG. 2. By lowering the stabilizer legs 19 (only one labeled), the trailer 1 may be lifted so that the wheels 15 are lifted off the ground to prevent movement of the trailer 1 during operation. The articulated boom 5 may be unfolded so that the arms 25, 27, 29 may achieve a variety of configurations resulting in a variety of different positions relative to the ground that the end effector 13 can achieve. Trace line 40 illustrates one potential path along which the end effector 13 may travel while the articulated boom 5 unfolds and refolds. Five of the possible positions along trace line 40 are illustrated, one in solid lines and four in dotted lines. In addition, one or more arms 25, 27, 29 may be extensible. For example, one or more of the arms 25, 27, 29 may be telescoping. A telescoping arm may preferably comprise an arm-within-arm arrangement whereby an internal arm is extended out (or retracted into) an outer arm, for example with use of a hydraulic cylinder in the arm. FIG. 2 illustrates telescopic extension of arm 27 with extension portion 38. Further, the extension portion 38 may comprise an arm-within-arm telescoping arrangement illustrated as further extension portions 38′ and 38″. In the embodiment illustrated in FIG. 2, the end effector 13 may achieve a height from the ground of over 70 feet, and may reach as much as 40 feet or more to a side. Different paths and positions for the end effector 13 may be achieved using different combinations of unfolding and telescoping. The wide variety of operational configurations is very useful for being able to properly position the nozzle on the end effector 13 for effective and accurate fluid delivery, as well as for piercing structures in firefighting operations.

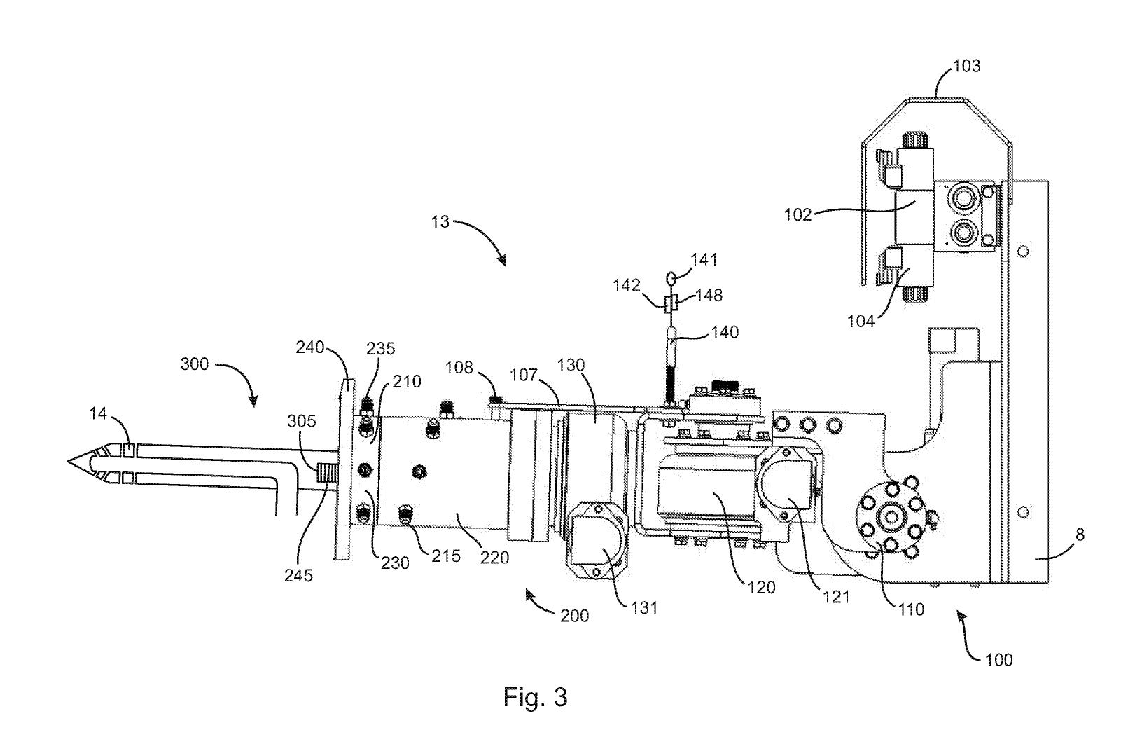

FIG. 3 illustrates an embodiment of the end effector 13 and components thereof. The end effector 13 may comprise a main body 100, a head 300 and a multiport hydraulic swivel 200 disposed between the main body 100 and the head 300. The end effector mount 8, for mounting the end effector 13 on the far end of the articulated boom as described above, may be conveniently mounted on a rear end of the main body 100.

In addition to the end effector mount 8, the main body 100 may comprise a hydraulic valve manifold 102 housed under a valve manifold cover 103. The hydraulic valve manifold 102 comprises a sufficient number of hydraulic valves to run all of the hydraulic operations of the end effector 13. The hydraulic valves receive hydraulic fluid from one or more main hydraulic lines that extend from the hydraulic fluid reservoir on the trailer, along the boom to arrive at the hydraulic valve manifold 102. In this embodiment, the hydraulic valve manifold 102 comprises center-spool solenoids 104 (only one labeled), each of the solenoids 104 comprising an inlet and outlets, the inlet receiving hydraulic fluid from the hydraulic fluid reservoir and the outlets providing hydraulic fluid to hydraulically operated parts of the end effector 13. The hydraulic valve manifold 102 with center-spool solenoids 104 may be any suitable commercially available device, for example a Bosch Type M4-12 load sensing control block.

In the illustrated embodiment, a first solenoid controls hydraulic fluid pressure at a first hydraulic motor drivingly connected in a first high gear ratio slew drive 110 for driving up and down motion of the end effector 13 at a first end effector joint. A second solenoid controls hydraulic fluid pressure at a second hydraulic motor drivingly connected in a second high gear ratio slew drive 120 for driving right and left motion of the end effector 13 at a second end effector joint. A third solenoid controls hydraulic fluid pressure at a third hydraulic motor drivingly connected in a third high gear ratio slew drive 130 for driving rotation of the head 300 of the end effector 13 at a third end effector joint. Other solenoids may be present to drive other hydraulic components of the end effector, for example a hydraulically actuated piercer associated with a nozzle mounted on the end effector.

Hose guides 140 (only one labeled) may be used to retain and organize hydraulic lines extending from the hydraulic valve manifold 102 to hydraulic fluid ports 215 (only one labeled) located on the swivel 200. One or more of the hose guides 140 may also serve as convenient locations to mount one or more lights 141 and/or cameras 142 oriented to illuminate and/or image the nozzle 14 mounted on a mounting plate 240 on the swivel 200 of the end effector 13. The camera or cameras 142 may be for taking still and/or video images, may be a thermal imaging camera, and may permit a remote operator to see the location to which the fluid is to be delivered. For example, using the camera 142, the operator is able to target a specific location on the envelope of a building to ensure that the nozzle 14 is in the correct orientation.

A wireless transmitter 148 on the end effector 13 or on any other portion of the trailer 1 may collect data from various sensors (e.g. cameras, temperature gauges, wind speed gauges, timers, altimeters and the like) as well as information about equipment usage time, maintenance needs, etc. and transmit the data to a remote location. Integrating a global positioning system (GPS) with the wireless data transmission may provide location information related to the data being collected.

The multiport hydraulic swivel 200 disposed between the main body 100 and the head 300. The swivel 200 may comprise a rotatable cylindrical body 210 disposed inside a non-rotatable casing 220. The rotatable cylindrical body 210 may be drivingly connected to the third slew drive 130 so that rotation of the drive 130 rotates the cylindrical body 210 inside the casing 220. The cylindrical body 210 may be fixedly mounted on the head 300 via the mounting plate 240 so that rotation of the cylindrical body 210 causes rotation of the head 300. The cylindrical body 210 may be supported by bearings mounted inside the casing 220, permitting the cylindrical body 210 to rotate freely within the casing 220. The casing 220 may be prevented from rotating by being fixedly mounted to the main body 100 in any suitable way, for example by a mounting bracket 107 with a bolt 108. The cylindrical body 210 may be mounted to the third slew drive 130 by fixedly securing the cylindrical body 210 to a rotating face of the slew drive 130.

The cylindrical body 210 may comprise a series of concentric annular channels on an outer surface of and around a circumference of the cylindrical body 210 inside the casing 220. The casing 220 may have a thickness sufficient so that an inner wall of the casing 220 forms a seal with cylindrical body 210, for example via O-rings. Hydraulic fluid ports 215 (only one labeled) through the casing are situated above the channels to provide hydraulic fluid to each channel from the hydraulic valve manifold 102. Hydraulic fluid is maintained in each channel and prevented from entering neighbouring channels by seals, for example O-rings.

The swivel 200 may further comprise an annular ring 230, which is mounted on or forms part of the cylindrical body 210, and which rotates with the cylindrical body 210. The annular ring 230 may be in the form of a disc. The annular ring 230 may be disposed between the casing 220 and the head 300, and the annular ring 230 may be fixedly mounted on the head 300, for example by a threaded bolt 245 fixed to the mounting plate 240 fixedly mounted on the annular ring 230, the bolt 245 threaded into a corresponding threaded bolt hole 305 in the head 300. Rotation of the annular ring 230 thereby causes the head 300 to rotate. Hydraulic fluid ports 235 (only one labeled) through the ring 230 may be in fluid communication with the ports 215 on the swivel 200.

In this way, hydraulic lines (not shown) connecting the hydraulic valve manifold 102 to a hydraulic motor of the first slew drive 110, to a hydraulic motor of the second slew drive 100, to a hydraulic motor of the third slew drive 130 and to the swivel 200 do not rotate as the head 300 rotates, respectively, while hydraulic lines (not shown) connecting the swivel 200 to hydraulically operated components on the head 300 do rotate with the head 300. This arrangement permits 360° continuous rotation of the head 300 as well as up/down and right/left motion of the end effector 13 without wrapping hydraulic lines around the end effector 13. This arrangement also reduces overall length of hydraulic lines, and reduces dangling of the hydraulic lines thereby reducing the probability that hydraulic lines will get caught in obstructions. Hydraulic lines in the present arrangement are less prone to damage, damaged lines being more prone to causing hydraulic pressure failure.

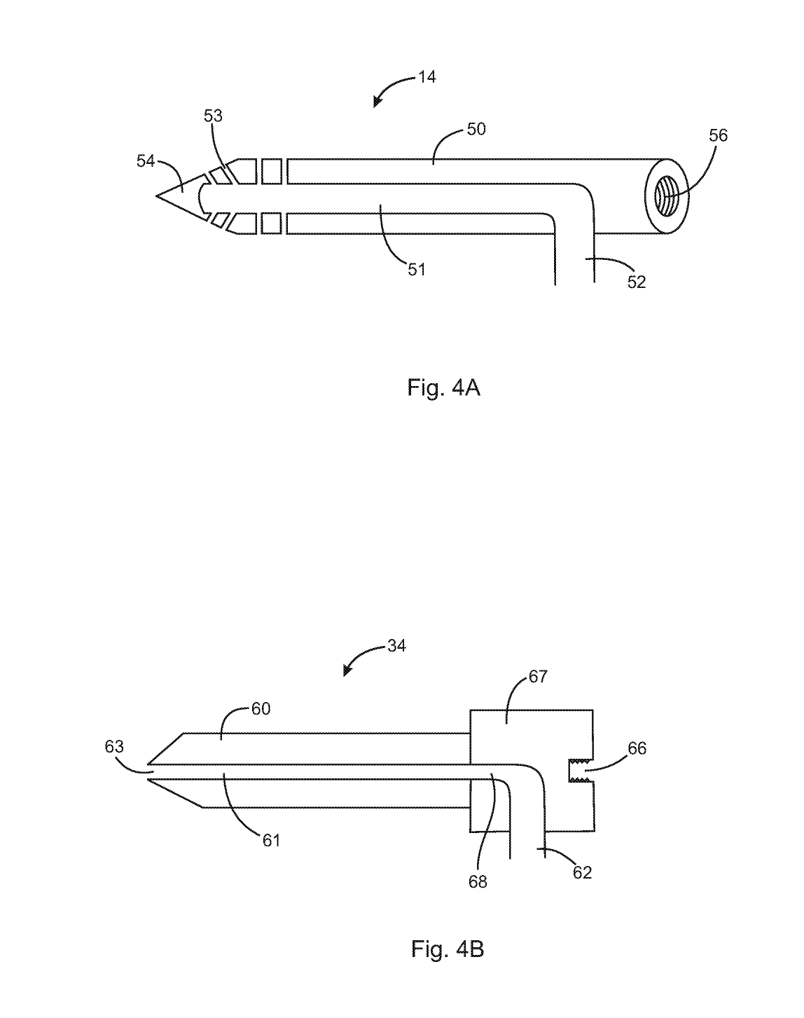

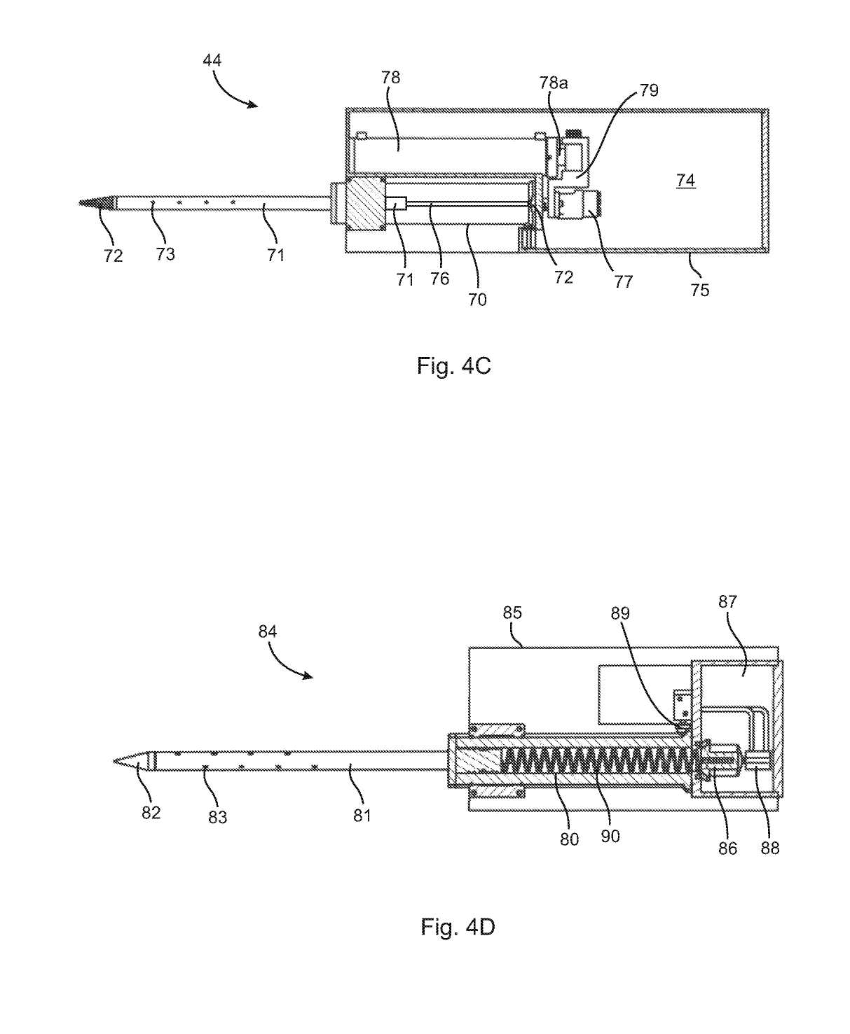

The head 300 may comprise the nozzle 14 (in this embodiment a piercing nozzle as illustrated in FIG. 4A and described below). The head 300 may be mounted on the annular ring 230 by the bolt 245 in the bolt hole 305 as described above. The head 300 may be readily exchanged for a different head suited for the same or a different water delivery purpose by unscrewing the head 300 from the bolt 245 and screwing on a different head. Other releasable mounting arrangements may be employed instead of or in addition to a bolt in a bolt hole by suitably designing the mounting plate 240 and the head 300 with appropriate connecting structures, some examples of which having been disclosed above. To reduce the possibility of the nozzle decoupling from the rest of the end effector, more than mounting arrangement may be used.

FIG. 4A illustrates a nozzle 14 designed for piercing a structure and delivering an aerosol of fluid in a firefighting operation, which can be used on the end effector in conjunction with the boom to deliver firefighting fluid inside a structure without creating a large hole in the structure. The nozzle 14 comprises a generally cylindrical solid body 50 having a fluid flow channel 51 oriented generally longitudinally in the body 50. The fluid flow channel 51 is in fluid communication with a fluid inlet 52, the fluid inlet 52 fitted with a hose (not shown) in fluid communication with the fluid tank on the trailer. The fluid inlet 52 extends radially outwardly from the body 50 proximate a first end of the body 50. The fluid flow channel 51 is also in fluid communication with one or more generally radially oriented aerosolizing outlets 53 (only one of eight labeled) situated proximate a second end of the body 50. A firefighting fluid under pressure may be pumped from the tank through the hose into the inlet 52 down the fluid flow channel 51 and out the outlets 53 to form a mist at a desired location. The mist both cools the fire and deprives the fire of oxygen, thereby helping quench the fire. The second end of the body 50 forms a piercing tip 54 that can be driven through a structure by action of the boom to ensure that the outlets 53 are at the desired location in the structure without making too big of a hole in the structure. The body 50 may be made of a robust, high melting point material (e.g. a metal, for example steel) to provide durability under extreme heat conditions. The first end of the body 50 comprises a threaded aperture 56 that may be threaded on to a mated threaded bolt mounted on the rest of the end effector. The nozzle 14 may be readily mounted and demounted from the end effector by screwing the nozzle 14 on and off the mated threaded bolt. While the threaded aperture 56 is illustrated as being longitudinally aligned with the fluid flow channel 51 and the inlet 52 extending radially from the body 50, any other configuration may be suitable, for example having the inlet 52 longitudinally aligned with the fluid flow channel 51 and the threaded aperture oriented radially from the body 50.

FIG. 4B illustrates a nozzle 34 designed for spray jet cleaning, which can be used on the end effector in conjunction with the boom to deliver pressurized cleaning fluid at difficult to reach locations, like transmission towers. The nozzle 34 comprises a generally cylindrical solid body 60 having a fluid flow channel 61 oriented generally longitudinally in the body 60. The fluid flow channel 61 is in fluid communication with a fluid inlet 62, the fluid inlet 62 fitted with a hose (not shown) in fluid communication with the fluid tank on the trailer. The fluid inlet 62 extends radially outwardly from a mounting block 67 attached to the body 60 proximate a first end of the body 60 and a curved channel 68 in the mounting block 67 fluidly connects the inlet 62 to the fluid flow channel 61. The fluid flow channel 61 is also in fluid communication with one or more outlets 63, in this case one outlet, configured to spray pressurized fluid out a second end of the body 60. A cleaning fluid under pressure may be pumped from the tank through the hose into the inlet 62 down the fluid flow channel 61 and out the outlet 63 to form a jet of fluid to facilitate cleaning of a desired surface. The body 60 may be made of any suitable material that can withstand the pressure of the fluid, for example a metal (e.g. steel, aluminum) and/or a plastic (e.g. polycarbonate). The mounting block 67 comprises a threaded aperture 66 that may be threaded on to a mated threaded bolt mounted on the rest of the end effector. The nozzle 34 may be readily mounted and demounted from the end effector by screwing the mounting block 67 on and off the mated threaded bolt. While the threaded aperture 66 is illustrated as being longitudinally aligned with the fluid flow channel 61 and the inlet 62 extending radially from the mounting block 67, any other configuration may be suitable, for example having the inlet 67 longitudinally aligned with the fluid flow channel 61 and the threaded aperture oriented radially from the mounting block 67.

FIG. 4C illustrates another embodiment of a nozzle 44 designed for piercing a structure and delivering an aerosol of fluid in a firefighting operation, which can be used on the end effector in conjunction with the boom to deliver firefighting fluid inside a structure without creating a large hole in the structure. The nozzle 44 comprises a generally cylindrical hollow body 70 within which is situated a hollow fluid flow tube 71 oriented generally longitudinally in the body 70. The fluid flow tube 71 is in fluid communication with the hollow body 70, and the hollow body 70 comprises a fluid inlet 72 in fluid communication with an interior volume 74 of a fluid-tight housing 75 within which the hollow body 70 is situated. The interior volume 74 is in fluid communication with the fluid tank on the trailer. The fluid flow tube 71 is also in fluid communication with one or more generally radially oriented aerosolizing outlets 73 (only one labeled) situated proximate a distal end of the fluid flow tube 71. Pressurized fluid pumped from the fluid tank enters the interior volume 74, passes through the fluid inlet 72 into the hollow body 70 passing into the fluid flow tube 71 and out the outlets 73 to form a mist at a desired location. A proximal end of the fluid flow tube 71 is connected to a driving rod 76 rotationally driven by a screw motor 77. Rotation of the fluid flow tube 71 by the screw motor 77 permits a drill bit 72 at the distal end of the fluid flow tube 71 to drill through a structure to ensure that the outlets 73 are at the desired location in the structure without making too big of a hole in the structure. Longitudinal translation of the fluid flow tube 71 may be achieved with a hydraulic cylinder 78 mounted to the housing 75 in the interior volume 74. A cylinder rod 78a of the hydraulic cylinder 78, the screw motor 77 and the driving rod 76 are supported together on a support 79 within the interior volume 74 such that the support 79, screw motor 77 and driving rod 76 translate longitudinally when the cylinder rod 78a is extended or retracted. Movement of the cylinder rod 78a thereby moves the fluid flow tube 71 longitudinally permitting the drill bit 72 to bore through the structure to place the outlets 73 within the structure. The nozzle 44 may be mounted on the end effector in any desired manner, for example by bolting the housing 75 on the end effector.

FIG. 4D illustrates yet another embodiment of a nozzle 84 designed for piercing a structure and delivering an aerosol of fluid in a firefighting operation, which can be used on the end effector in conjunction with the boom to deliver firefighting fluid inside a structure without creating a large hole in the structure. The nozzle 84 comprises a generally cylindrical hollow body 80 within which is situated a hollow fluid flow tube 81 oriented generally longitudinally in the body 80. The fluid flow tube 81 is in fluid communication with the hollow body 80 proximate a proximal end of the fluid flow tube 81, and in fluid communication with one or more generally radially oriented aerosolizing outlets 83 (only one labeled) situated proximate a distal end of the fluid flow tube 81. The hollow body 80 is housed within a housing 85, the hollow body 80 in fluid communication with a fluid containment chamber 87 situated within the housing 85. The fluid containment chamber 87 is in fluid communication with the fluid tank on the trailer. Fluid flow from the fluid containment chamber 87 to the hollow body 80 is controlled by a first valve 86, operation of the first valve 86 being controlled by a hydraulic cylinder 88 mounted on the valve 86. Fluid flow from the hollow body 80 back to the fluid containment chamber 87 is controlled by a second valve 89. An extension spring 90 located within the hollow body 80 is attached at a proximal end to an immovable structure (e.g. a wall of the fluid containment chamber 87) and at a distal to the fluid flow tube 81. When fluid flow from the fluid tank on the trailer is switched on, the fluid under pressure fills the fluid containment chamber 87. Opening the first valve 86 while keeping the second valve 89 permits pressurized fluid from the fluid containment chamber 87 to enter the hollow body 80 thereby both entering the fluid flow tube 81 and driving the fluid flow tube 81 longitudinally out of the hollow body 80. Because the fluid flow tube 81 comprises a piercing tip 82 at a distal end thereof, the fluid flow tube 81 driven under pressure from the fluid is able to pierce through a structure to place the outlets 83 at a desired location in the structure. Pressurized fluid in the fluid flow tube 81 is sprayed out through the outlets 83 at the desired location in the structure. Driving the fluid flow tube 81 longitudinally out of the hollow body 80 causes the spring 90 to extend under tension. Provided pressurized fluid continues to flow, the spring 90 is unable to retract and the fluid flow tube 81 remains extended. Switching off fluid flow from the fluid tank and opening the second valve 89 reduces fluid pressure in the hollow body 80 thereby permitting the spring 90 to retract drawing the fluid flow tube 81 longitudinally back into the hollow body 80 and pushing fluid out of the hollow body 80 back through the second valve 89 into the fluid containment chamber 87. The nozzle 84 may be mounted on the end effector in any desired manner, for example by bolting the housing 75 on the end effector.

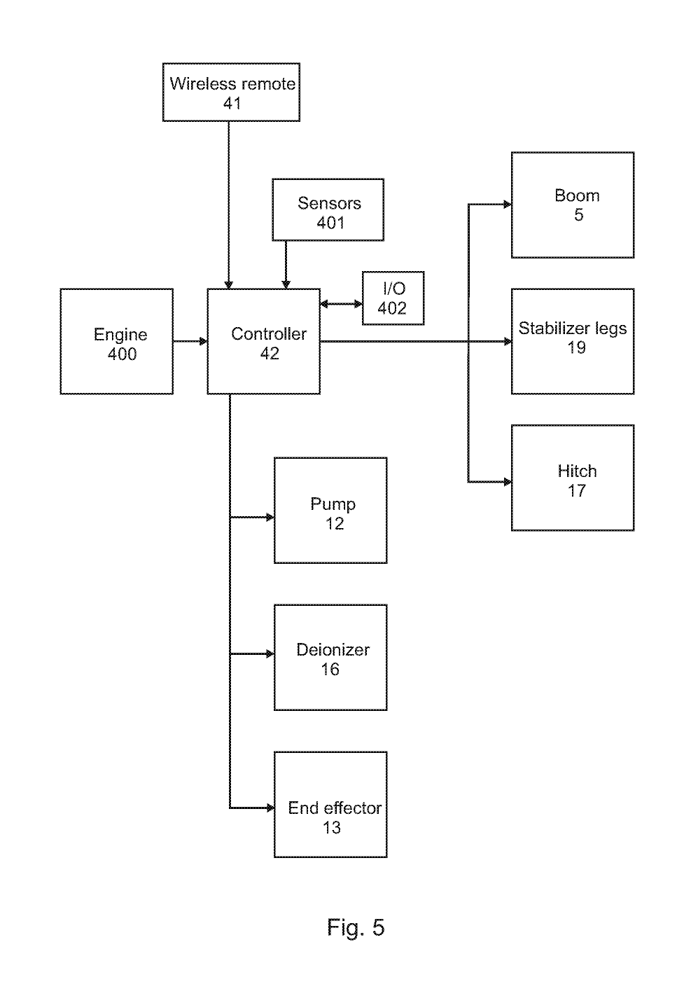

With reference to FIG. 5, the trailer 1, or any other embodiment of the trailer, may be provided with the controller 42 comprising circuitry programmed with machine logic that may synthesize data elements related to the status of the boom 5, stabilizer legs 19, hitch 17, pump 12, deionizer 16 and end effector 13 and data obtained from various sensor 401 located on the trailer. The controller 42 may be controlled by and may provide information to an operator by way of an input/output device 402 associated with the controller 42. The controller 42 may also receive signals from the wireless remote control 41 instead of or in addition to the input/output device 402 to permit an operator to control function of the trailer from a remote location. The controller 42 may receive power from an engine 400 mounted on the trailer, the engine 400 powering the controller 42 as well as the operation of the boom 5, stabilizer legs 19, hitch 17, pump 12, deionizer 16 and end effector 13. In some embodiments, the engine 400 may power one or more hydraulic pumps, which power one or more of the boom 5, stabilizer legs 19, hitch 17, pump 12 and end effector 13 through one or more hydraulic circuits.

The controller 42 may comprise a logic circuit, for example a programmable logic circuit (PLC), which may comprise one or more microprocessors. The programmable logic circuit may be configured to automatically control one or more aspects of operation of the trailer. For example, the logic circuit may be configured to simultaneously and automatically unlock the boom 5, unlock and lower the stabilizer legs 19 and detach the hitch 17 from the towing vehicle when the engine 400 is switched on, or upon activation of a single control switch on the controller 42 or remote control 41. Simultaneous and automatic operation in this manner permits raising the boom 5 very quickly, for example within 30 seconds of arriving at a location, which is particularly useful in firefighting application where time is of the essence. In another example, the logic circuit may be configured to automatically increase or decrease fluid pressure and/or adjust the position and/or angle of the nozzle based on information collected by the sensors 401.

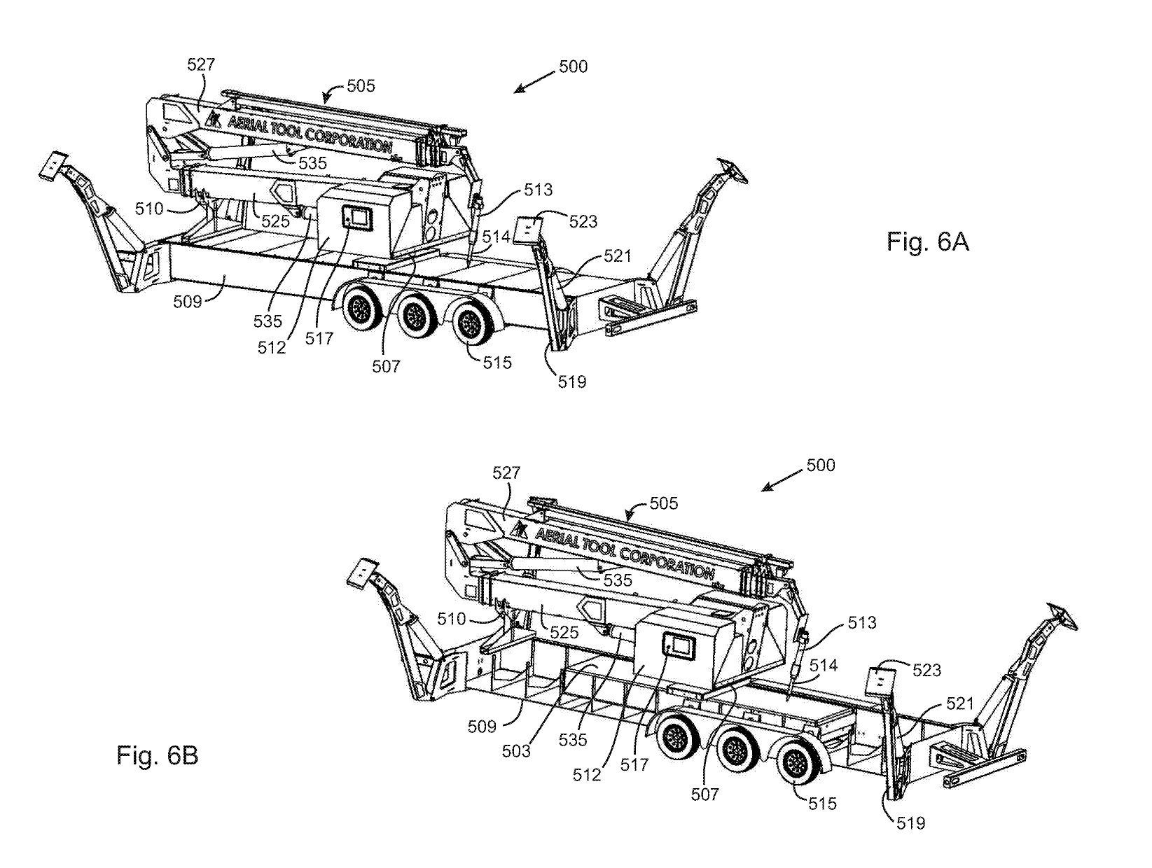

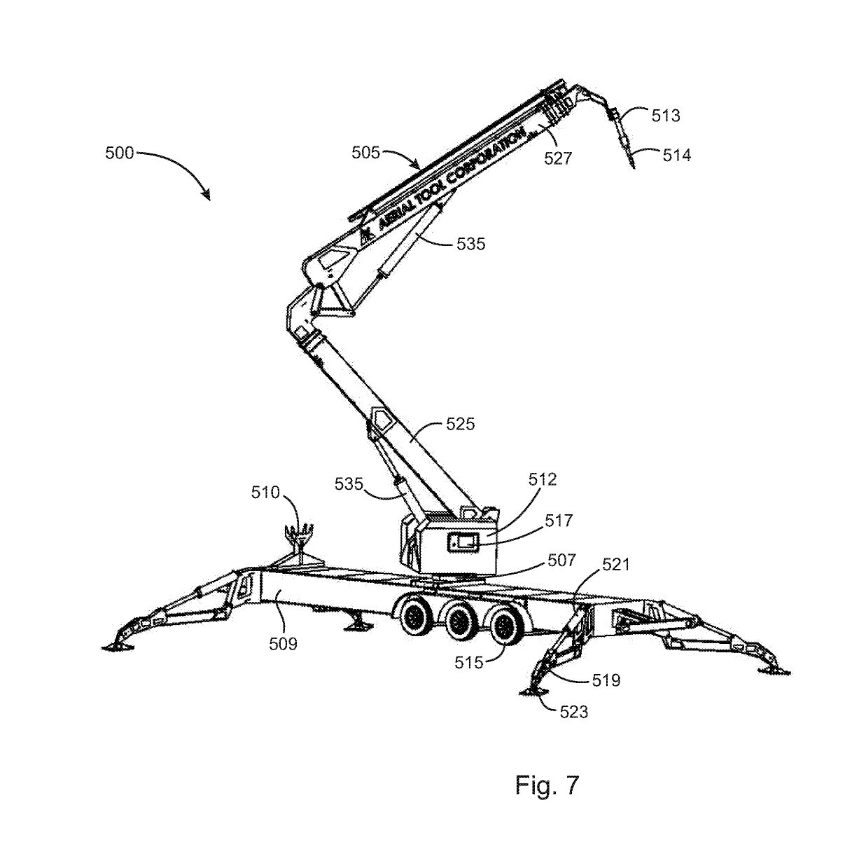

FIG. 6A, FIG. 6B and FIG. 7 depict a fluid delivery trailer 500 in accordance with a second embodiment of the present invention. The trailer 500 comprises an articulated boom 505 rotatably mounted and supported on the trailer 500 via a rotatable mount 507 at a near end of the boom 505. The boom 505 comprises two arms 525, 527. In the stowed position (FIG. 6A, FIG. 6B), the boom 505 is folded and further supported and secured on a securing bracket 510 for safety during transport. In the deployed position (FIG. 7), the boom 505 may be articulated in two dimensions perpendicular to the ground and the rotatable mount 507 may move the boom 505 through a third dimension parallel to the ground. Articulation of the boom 505 is accomplished with hydraulic cylinders 535. An end effector 513 is mounted at a far end of the boom 505. The end effector 513 comprises a nozzle 514 for spraying fluid. The nozzle 514 is in fluid communication with a fluid supply, for example water, fire suppressant or cleaning liquid, in a fluid tank 503 through a hose (not shown). A fluid pump (not shown) inside housing 512 is configured to pump fluid from the fluid tank 503 through the hose to the nozzle 514 on the end effector 513.

As seen in FIG. 6B, the fluid tank 503 is mounted within a frame 509 of the trailer 500. Mounting the fluid tank 503 within the frame 509 reduces the overall size and improves the stability of the trailer 500, while still retaining the option of providing an extra fluid supply tank on a frame extension or a tandem trailer. The housing 512 is supported on the rotatable mount 507, which is rotatably mounted on the frame 509 of the trailer 500. The housing 512 contains one or more of fluid pumps, a control system, a generator or engine, a water deionizer and other electrical and/or hydraulic components (e.g. a hydraulic fluid supply and pumps for operating hydraulic cylinders and other hydraulically powered parts) required to operate the trailer. The housing 512 and boom 505 may rotate with the rotatable mount 507 to permit positioning of the boom 505 and nozzle 514.

The trailer 500 rides on wheels 515 (only one labeled) and may be towed by a vehicle (not shown) by hitching the trailer 500 to the vehicle at a hitch. When the trailer 500 is in use, the trailer 500 may be stabilized on a surface (e.g. the ground) by stabilizer legs 519 (only one of labeled). In this embodiment four stabilizer legs 519 are present. The stabilizer legs 519 may be raised and lowered by any suitable mechanism, for example leg hydraulic cylinders 521 (only one labeled). FIG. 6A and FIG. 6B show the stabilizer legs 519 in a stowed raised position with the feet 523 (only one labeled) off the ground. Lowering the stabilizer legs 519 causes the feet 523 to engage the ground and partially or fully lift the wheels 515 of the trailer 500 off the ground so that the trailer 500 cannot roll on the wheels 515.

As with the trailer 1 described above, an operator may remotely control operation of various components of the trailer 500 using a wireless remote control or a controller 517 located on the trailer 500, for example on the housing 512. When the trailer 500 is parked as shown in FIG. 6A, a sensor (not shown) may be configured to activate a failsafe to prevent operation of the end effector 513. The failsafe may be configured to enable manual override in order to operate the end effector 513 for purposes of maintenance, testing, etc., if desired.

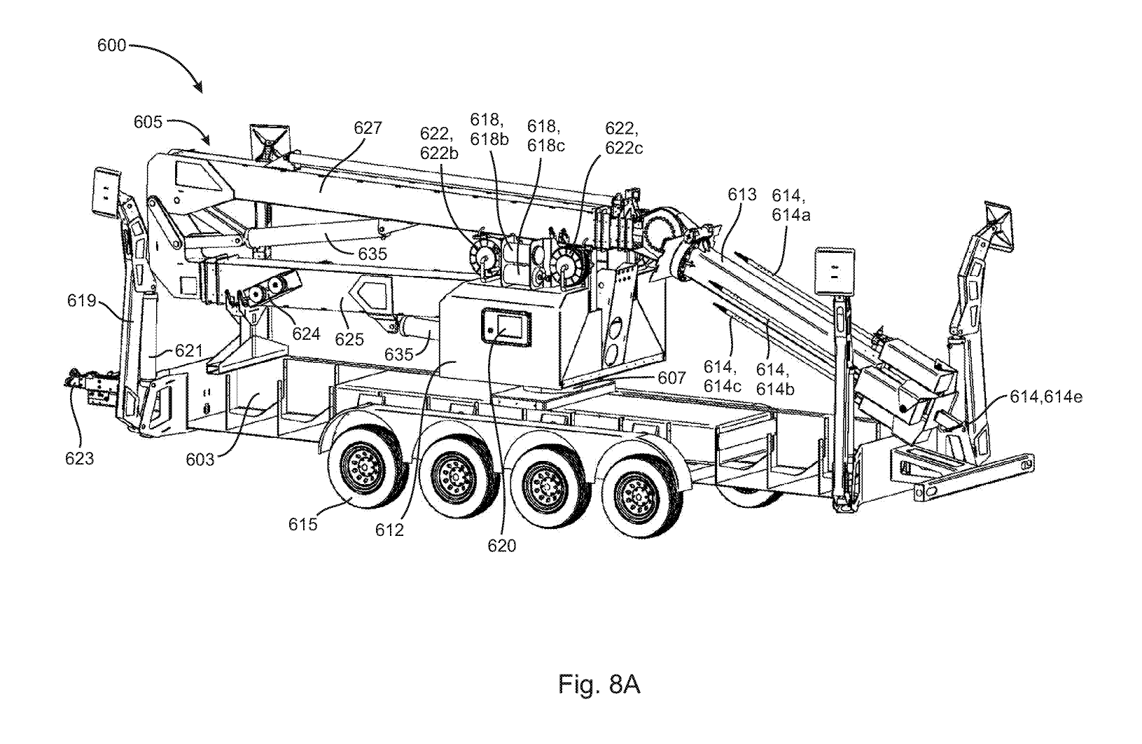

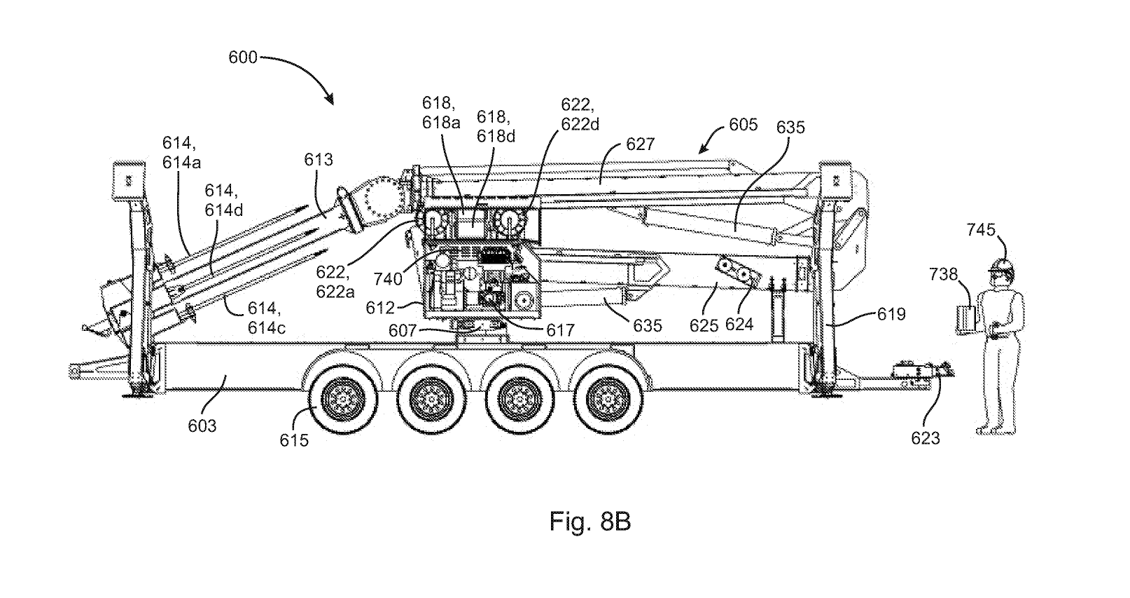

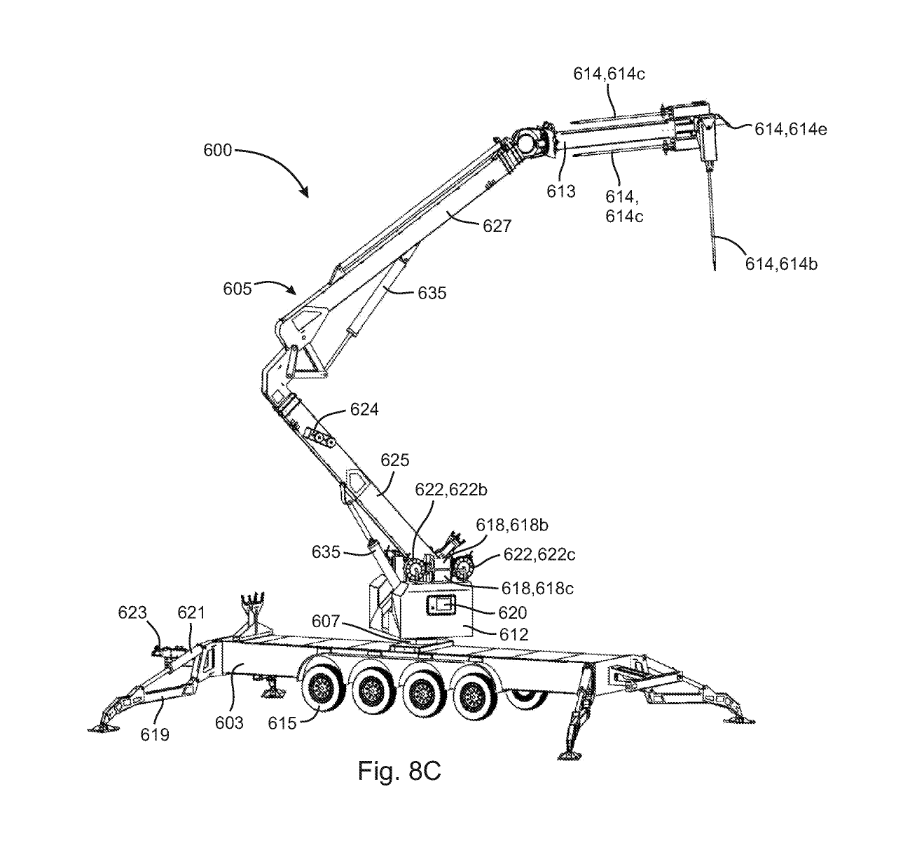

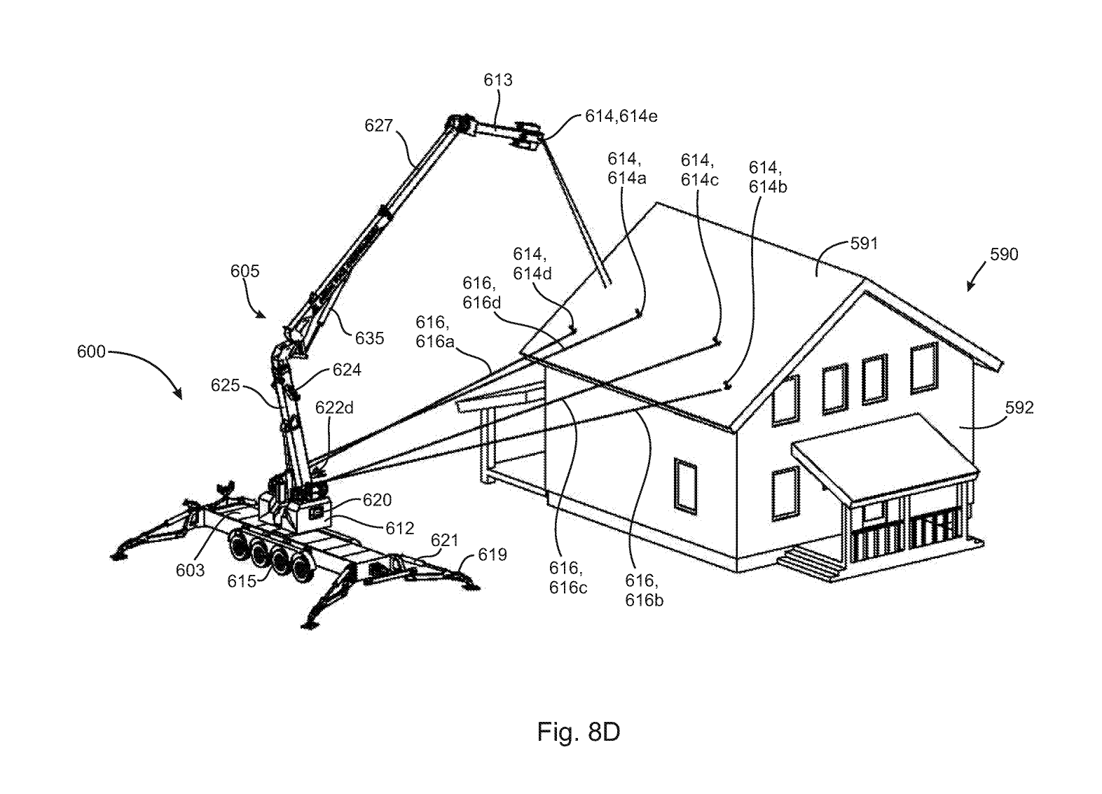

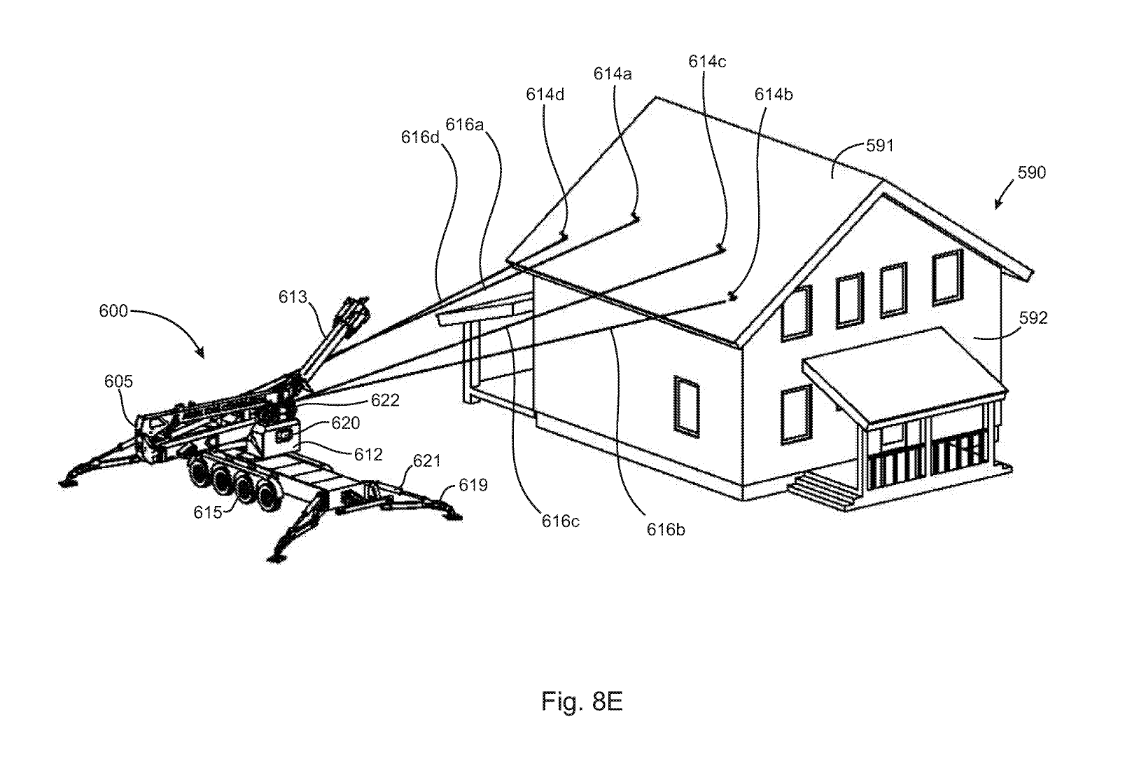

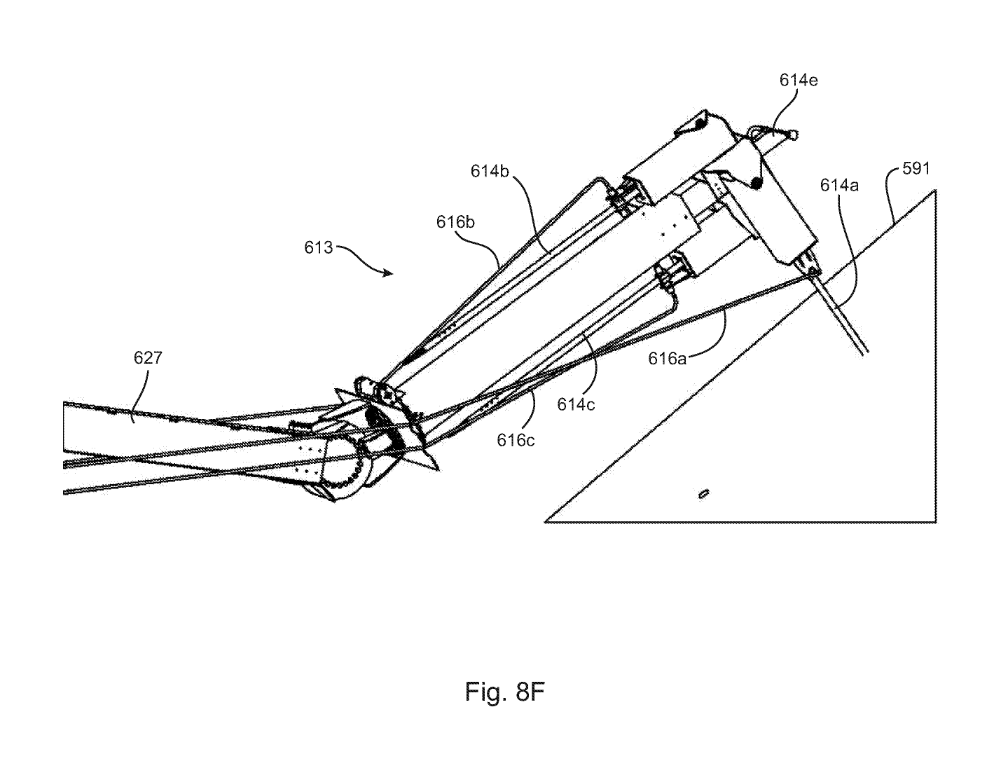

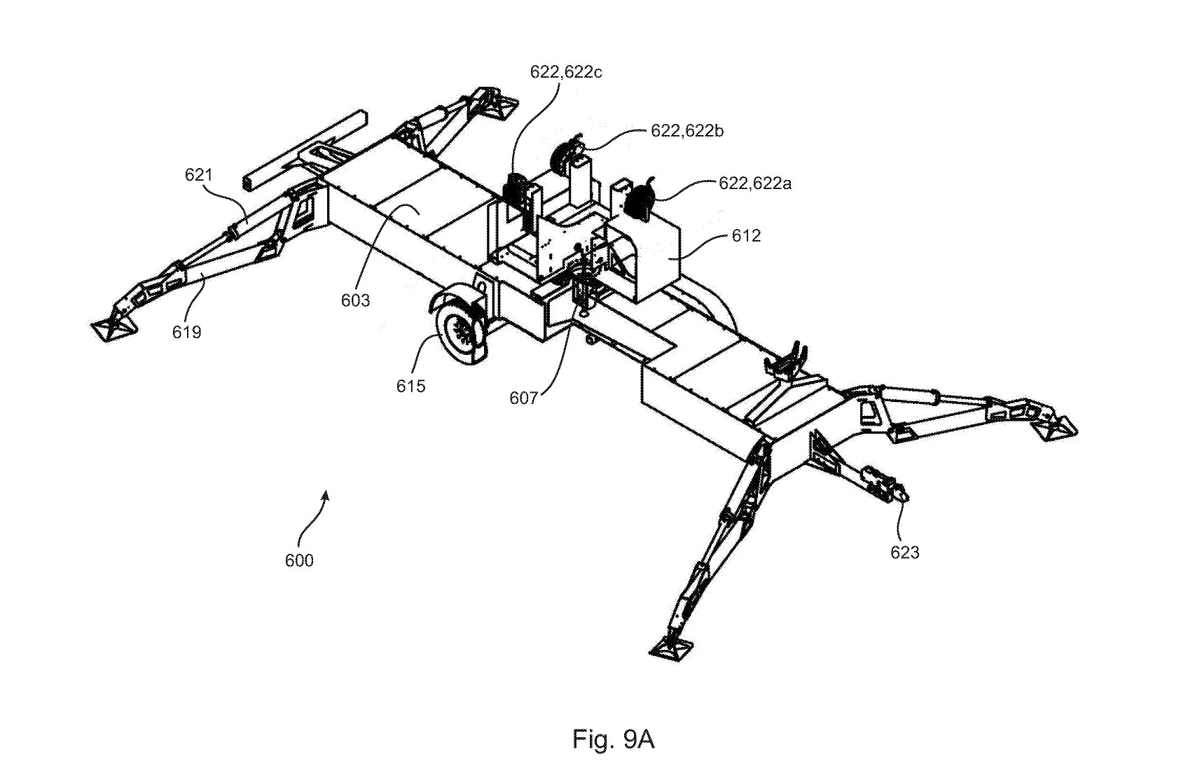

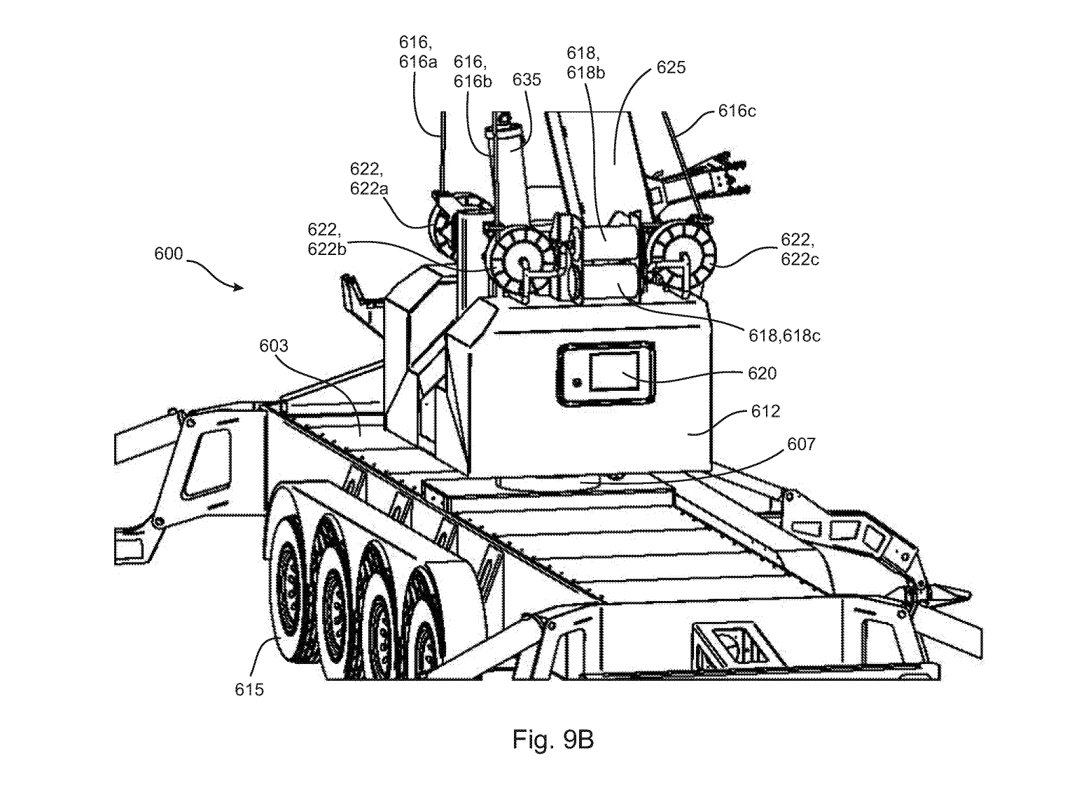

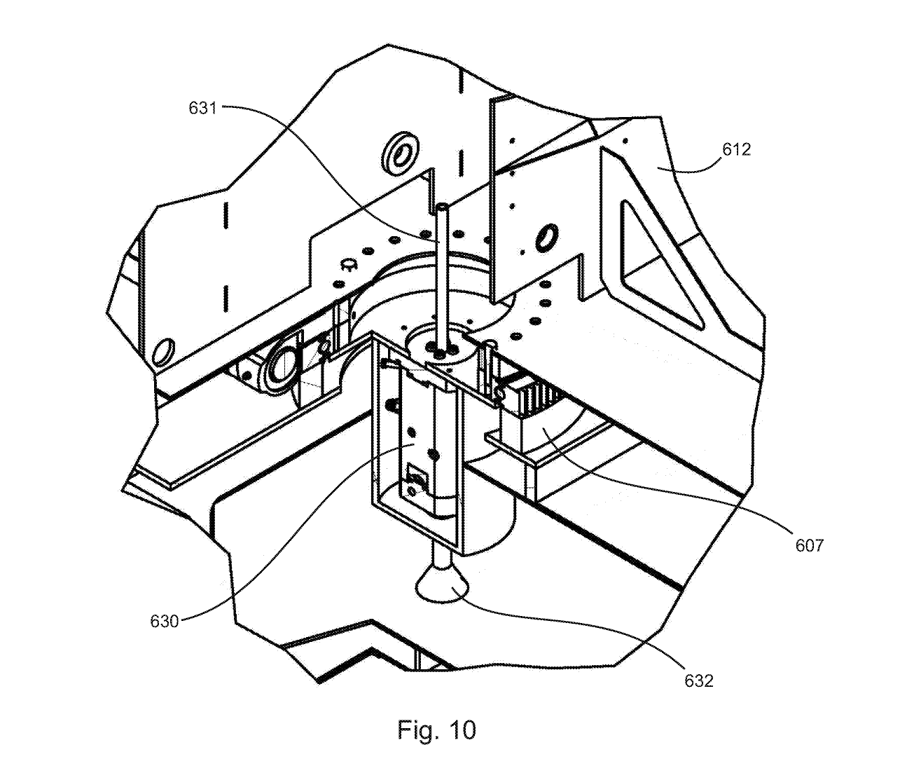

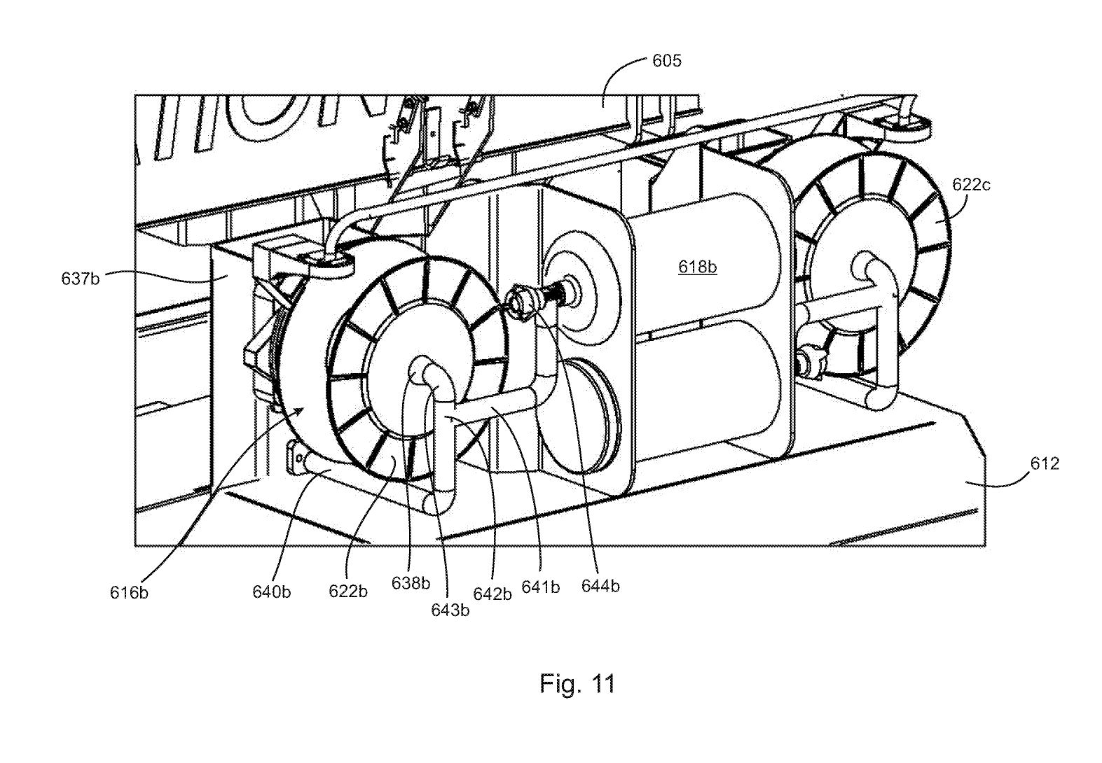

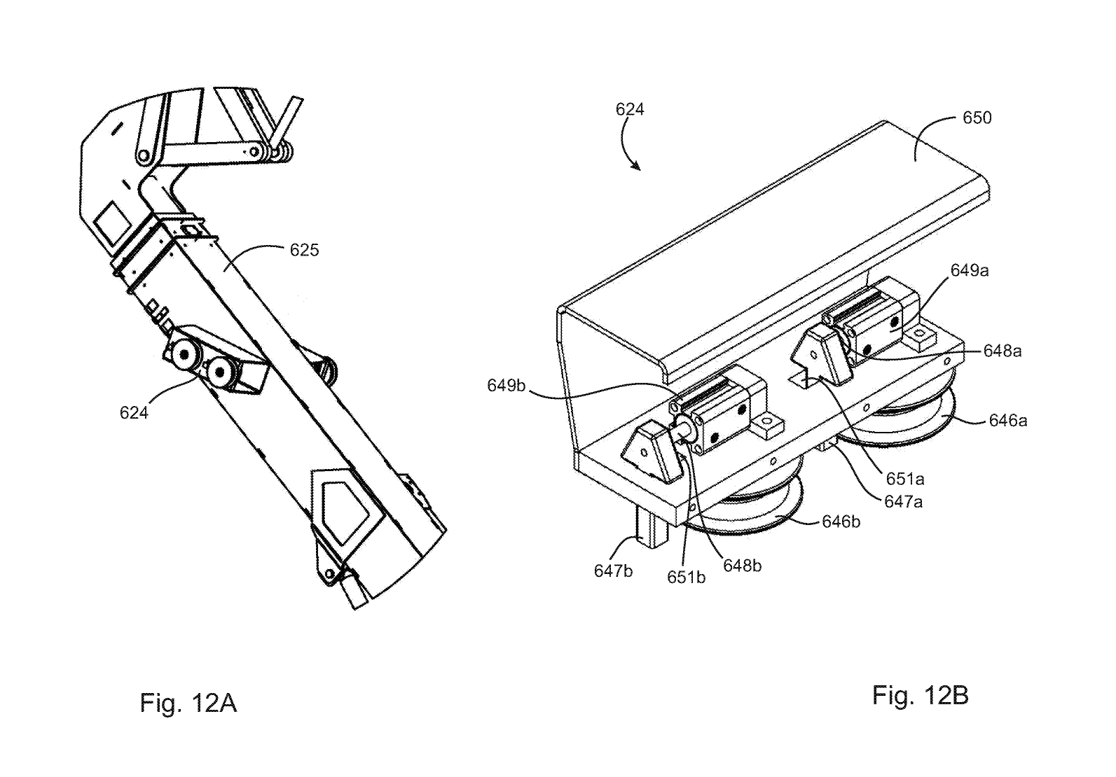

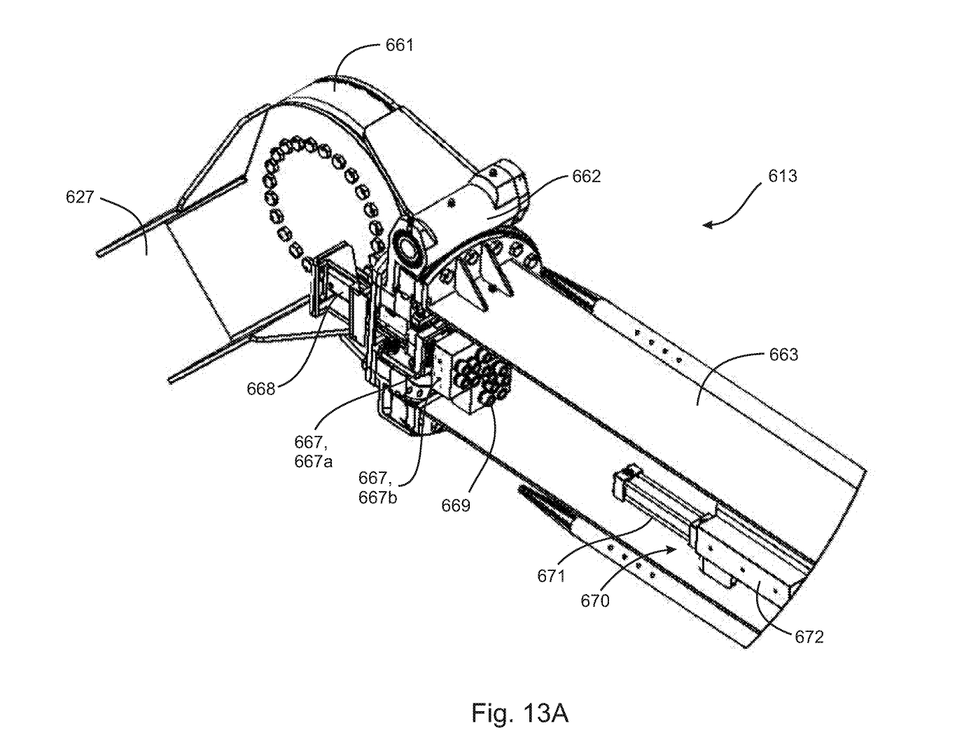

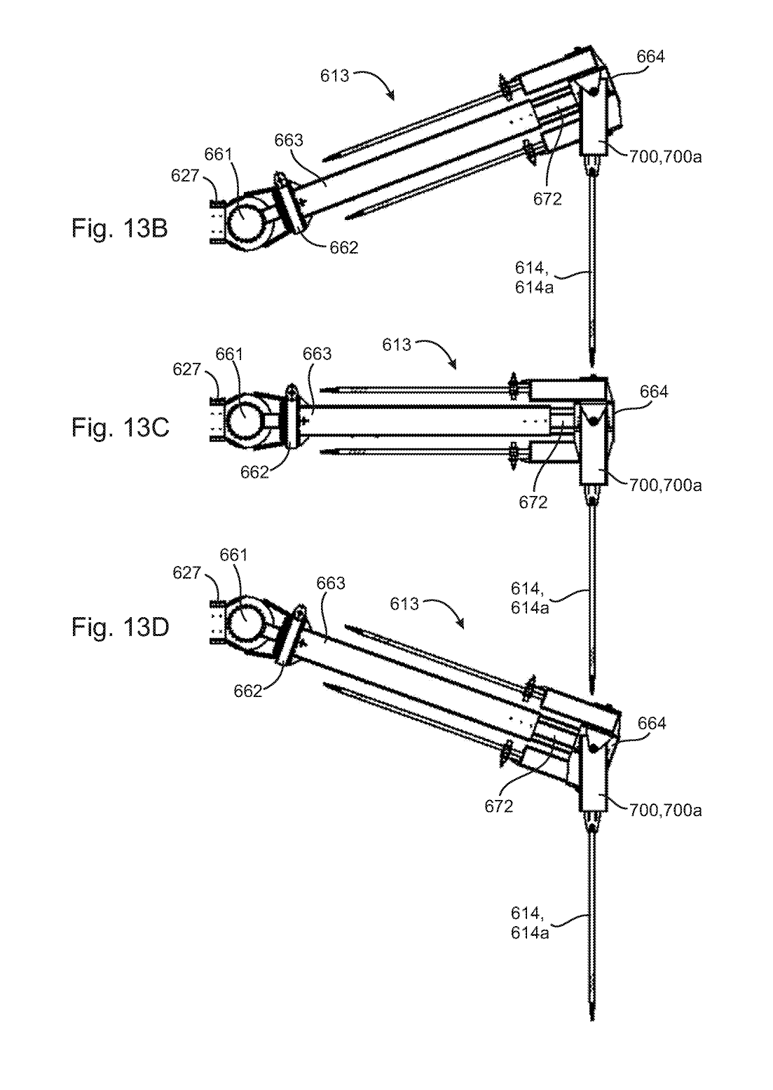

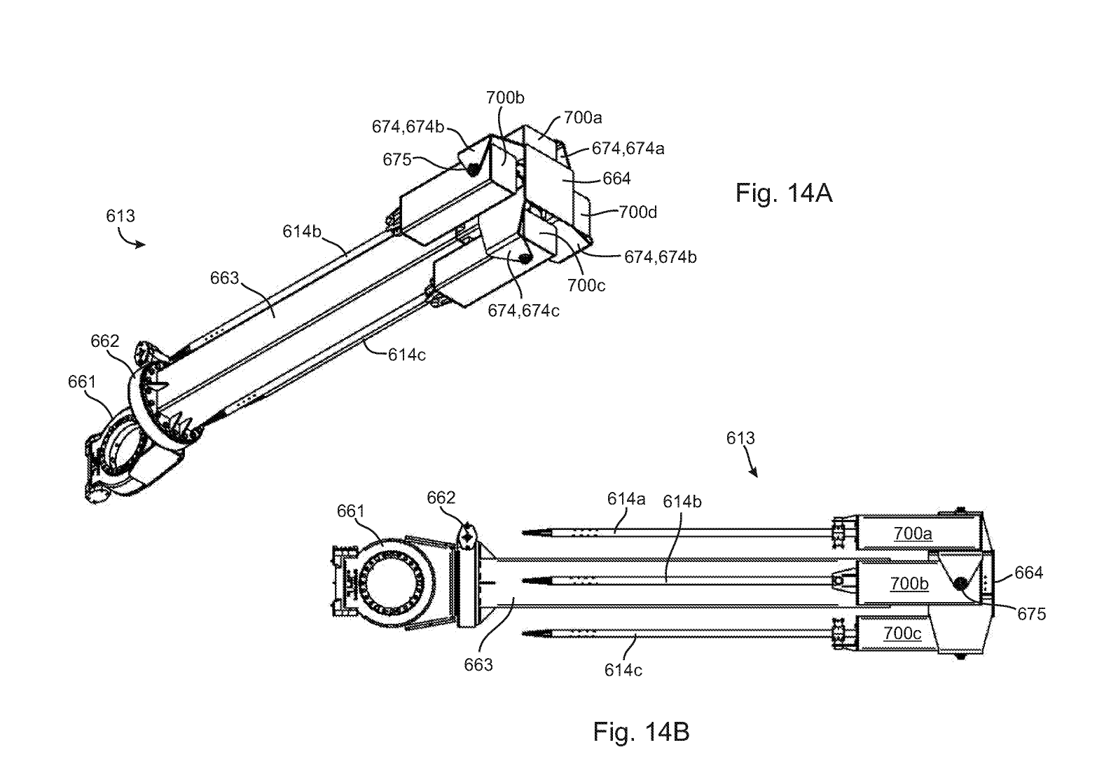

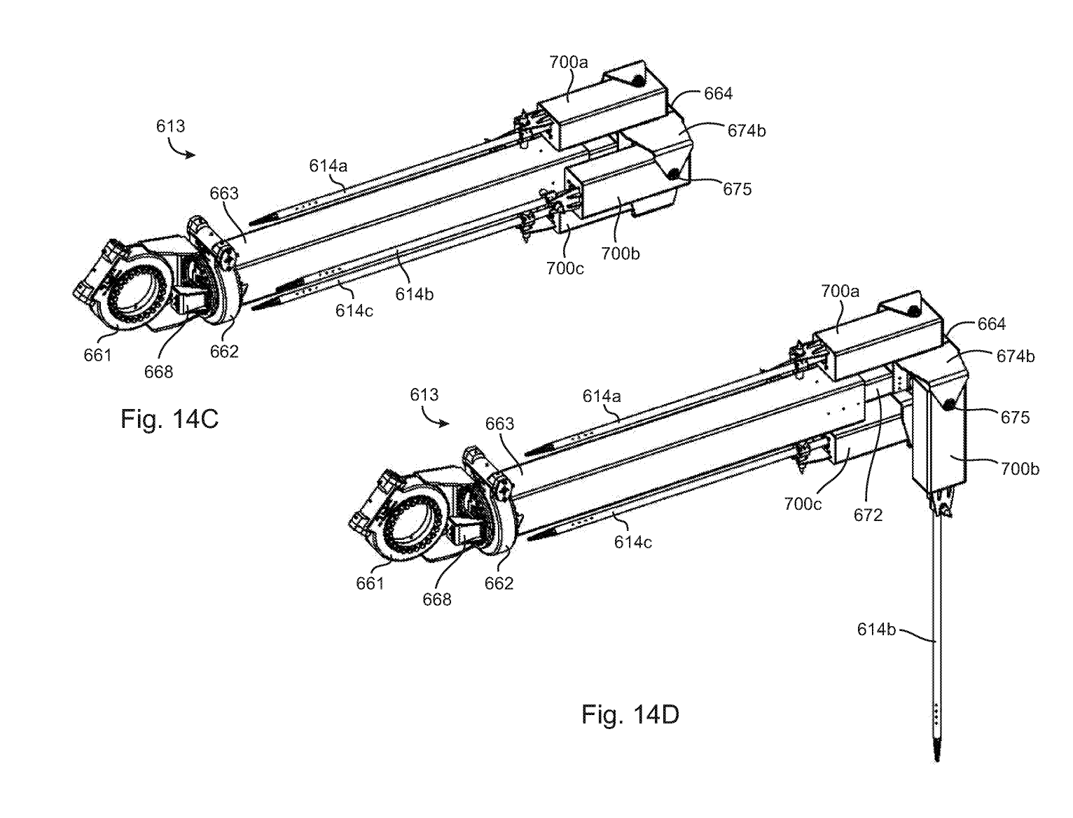

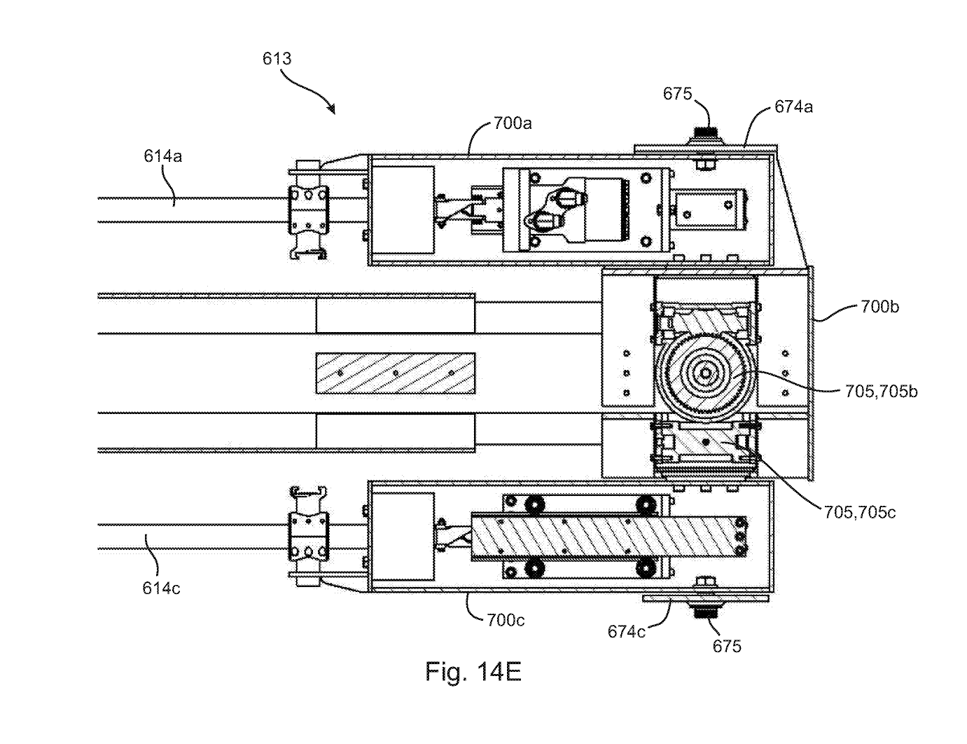

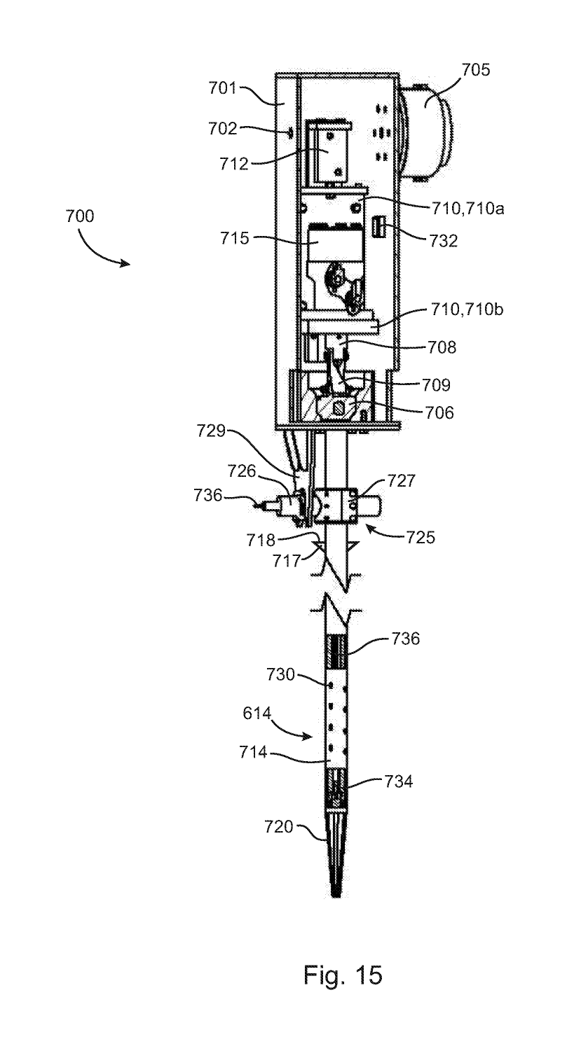

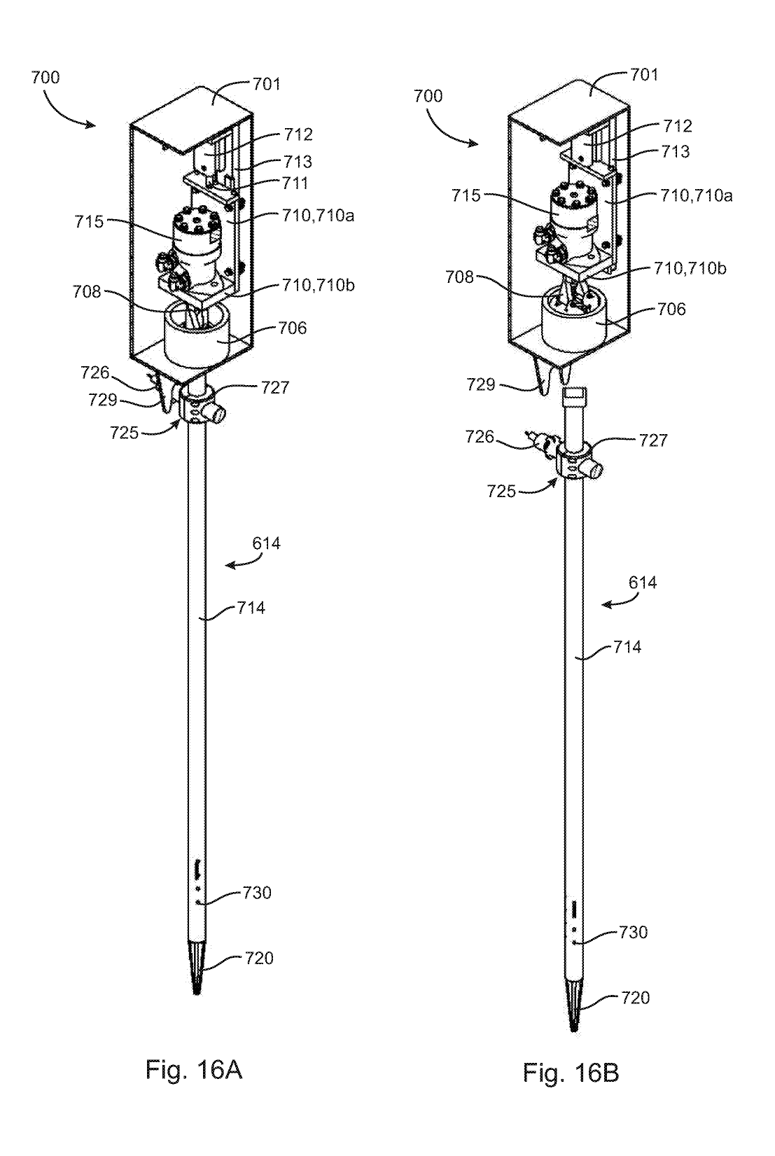

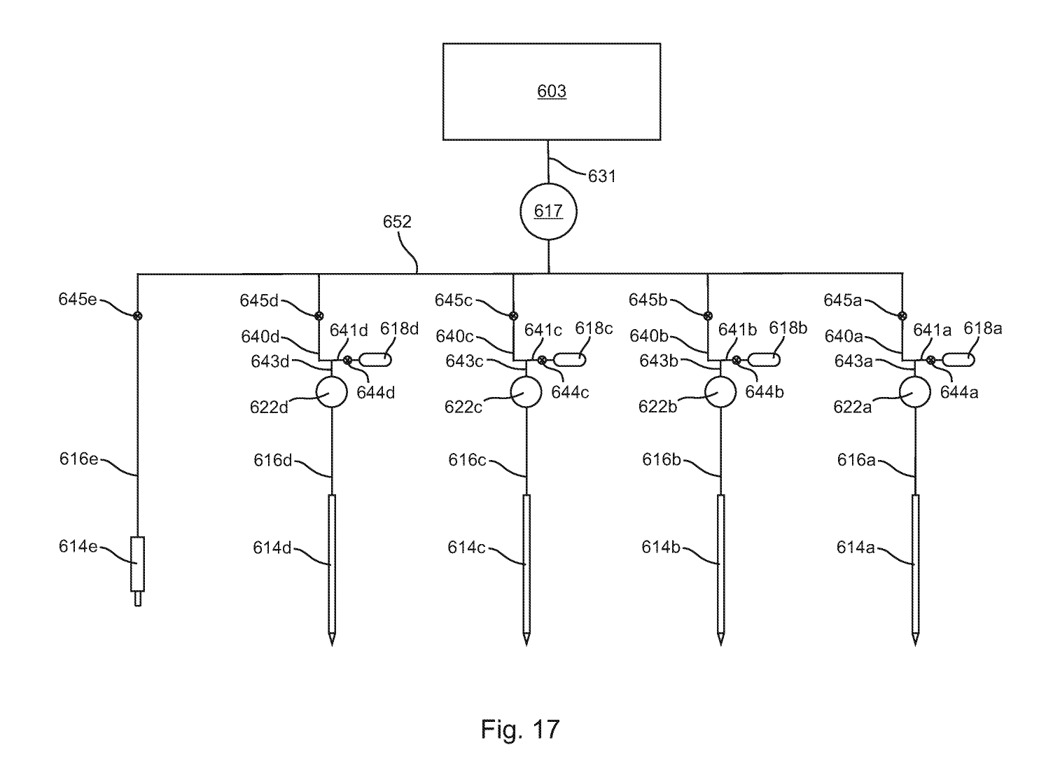

FIG. 8A, FIG. 8B, FIG. 8C, FIG. 8D, FIG. 8E, FIG. 8F, FIG. 9A, FIG. 9B, FIG. 10, FIG. 11A, FIG. 11B, FIG. 12A, FIG. 12B, FIG. 13A, FIG. 13B, FIG. 14A, FIG. 14B, FIG. 14C, FIG. 14D, FIG. 14E, FIG. 14F, FIG. 15, FIG. 16, FIG. 17A, FIG. 17B, FIG. 17 and FIG. 19 depict a fluid delivery trailer 600 in accordance with a third embodiment of the present invention.

With particular reference to FIG. 8A, FIG. 8B, FIG. 8C, FIG. 8D, FIG. 8E, FIG. 8F, FIG. 9A and FIG. 9B, the trailer 600 comprises an articulated boom 605 rotatably mounted on the trailer 600. The boom 605 is mounted in a housing 612, the housing 612 mounted and supported on the trailer 600 via a rotatable swivel 607. The boom 605 comprises a first arm 625 pivotally attached to a second arm 627. The boom 605 may be articulated in two orthogonal planes perpendicular to the ground and the rotatable swivel 607 may rotate the housing 612, and therefore the boom 605, through a third plane parallel to the ground. Articulation of the boom 605 is accomplished with hydraulic cylinders 635. An end effector 613 is mounted at a distal end of the boom 605.

The end effector 613 comprises multiple nozzles 614 as described below for spraying fluid. The multiple nozzles 614 comprise four detachable lances 614a, 614b, 614c, 614d that are releasable from the end effector 613 during operation, and one fixed nozzle 614e that is not releasable from the end effector during operation. The nozzles 614 are in fluid communication with fluid supplies through hoses 616. Only hoses 616a, 616b, 616c, 616d to the detachable lances 614a, 614b, 614c, 614d are labeled in FIG. 8D, whereas hose 616e to the fixed nozzle 614e is schematically illustrated in FIG. 17. A liquid pump 617 inside the housing 612 is configured to pump liquid from a liquid tank 603 through the hoses 616 to the nozzles 614. Four pressurized gas cylinders 618 (individually labeled as 618a, 618b, 618c, 618d in FIG. 8A, FIG. 8B and FIG. 9B) provide an inert gas through the hoses 616a, 616b, 616c, 616d to the four detachable lances 614a, 614b, 614c, 614d. The tank 603 is mounted within a frame of the trailer 600.

The housing 612 is supported on the rotatable swivel 607, which is rotatably mounted on the frame of the trailer 600. The housing 612 contains the liquid pump 617, a logic controller 620 for a control system, a generator or engine 740, and other electrical and/or hydraulic components (e.g. a hydraulic fluid supply and pumps for operating hydraulic cylinders and other hydraulically powered parts) required to operate the trailer 600. An operator 745 may control operations of the trailer 600 by using the controller 620 and/or a wireless remote controller 738. The trailer 600 rides on wheels 615 (only one labeled) and may be towed by a vehicle (not shown) by hitching the trailer 600 to the vehicle at a hitch 623. When the trailer 600 is in use as seen in FIG. 8C, FIG. 8D and FIG. 8E, the trailer 600 may be stabilized on a surface (e.g. the ground) by stabilizer legs 619 (only one of labeled). In this embodiment four stabilizer legs 619 are present. The stabilizer legs 619 may be raised and lowered by any suitable mechanism, for example leg hydraulic cylinders 621 (only one labeled).

As seen in FIG. 8D, the trailer 600 may be employed to fight a fire at multiple locations in and on a building 590. The four detachable lances 614a, 614b, 614c, 614d may each be driven through a roof 591 or a wall 592 of the building 590 at different locations and subsequently released to remain in the building 590 to fight hot spots at those locations. Hot spots may be determined by one or more sensors (e.g. an infrared camera) mounted on the boom 605. As seen in FIG. 8F with reference to the lance 614a, and as explained in more detail below, each detachable lance may be deployed into an operating position on the end effector 613 and driven through the roof 591 assisted by movement of the boom 605. The detachable lance 614a together with the hose 616a may then be released from the end effector 613 and the boom 605 deployed to drive another detachable lance into the building. With one or more of the detachable lances 614a, 614b, 614c, 614d driven into the building 590, the boom 605 may be deployed to spray liquid to cool an exterior surface of the building 590 as desired. The detachable lances 614a, 614b, 614c, 614d may be supplied with liquid and/or gas through their respective hoses 616a, 616b, 616c, 616d. Inert gas is preferably supplied first to smother the fire at the hot spot, followed by liquid (e.g. water) to cool the hot spot to ensure that the fire does not restart. Once deployed, all of the nozzles 614 may be operated simultaneously, but are selectively controllable.

The fixed nozzle 614e receives fluid from a hose (not shown) that is routed along the boom 605 from the liquid pump 617 to the end effector 613. As the boom 605 is relocated, the hose to the fixed nozzle 614e moves with the boom 605. The hoses 616a, 616b, 616c, 616d to the detachable lances 614a, 614b, 614c, 614d are also initially routed along the boom 605 through a hose guide 624 However, when a detachable lance is released, the corresponding hose must remain with the lance rather than follow the boom 605 while the boom 605 is being redeployed. To permit redeployment of the boom 605 without pulling a released lance out of the location in which the lance was deployed, the hoses 616 to the detachable lances 614a, 614b, 614c, 614d release from the hose guide 624. Further, the detachable lances 614a, 614b, 614c, 614d are mounted on hose reels 622 (622a, 622b, 622c, 622d). The hose reels 622 accommodated extra length of the hoses 616, which unwind as the boom 605 is redeployed when the detachable lances 614a, 614b, 614c, 614d have been released from the end effector 613. Once the firefighting operation is complete, fluid flows may be switched off and the boom 605 returned to a stowed position as illustrated in FIG. 8E. Detached lances 614a, 614b, 614c, 614d may be retrieved and remounted on the end effector 613, and the hoses 616a, 616b, 616c, 616d rewound on the hose reels 622.

With particular reference to FIG. 10, the rotatable swivel 607 on which the housing 612 is mounted and supported comprises a hydraulic rotary manifold 630 mounted on the frame of the trailer beneath the housing 612. Rotation of the rotary manifold 630 about a vertical axis causes the housing 612 to rotate, thereby rotating the boom 605 (not seen in FIG. 10) about the vertical axis. To ensure that liquid can be supplied at all times from the liquid tank 603 to the nozzles irrespective of how much or often the boom rotates, a low-pressure liquid line 631 is provided that extends through the rotary manifold 630 along the vertical axis about which the rotary manifold 630 rotates. The low-pressure liquid line 631 comprises a low-pressure intake 632 located in the liquid tank 603 below the rotary manifold 630. The liquid tank 603 may comprise a bottom surface that slopes downward to the location of the low-pressure intake 632 so that the low-pressure intake 632 is located at the bottom-most point in the liquid tank 603 to ensure maximum usage of available liquid. The sloped bottom permits liquid in the liquid tank 603 to continuously collect at the bottom-most point as the liquid is used up. The low-pressure liquid line 631 extends above the rotary manifold 630 to be connected to the liquid pump 617 (not seen in FIG. 10). The rotatable swivel 607 permits continuous 360° rotation of the housing 612 and the boom 605 without entangling any lines or hoses connecting the liquid tank 603 to the liquid pump 617.

With particular reference to FIG. 11, details of the of the hose reels 622b, 622c mounted on the housing 612 are illustrated, and are described herein with reference to the hose reel 622b. The hose reel 622b is rotationally mounted on a hose reel support 637b, which is mounted on the housing 612. The hose, generally indicated at 616b, is wound on the reel 622b and a first end of the hose 616b is connected to a reel inlet 638b in fluid communication with the liquid pump 617 through a high-pressure liquid line 640b and in fluid communication with the pressurized gas cylinder 618b through a high-pressure gas line 641b. A second end of the hose 616b is in fluid communication with the detachable lance 614b. The high-pressure liquid line 640b and high-pressure gas line 641b are joined at a T-joint 642b forming a single high-pressure fluid line 643b connected to the reel inlet 638b. An electronically controllable valve 644b (e.g. a solenoid valve) between the pressurized gas cylinder 618b and the high-pressure gas line 641b controls gas flow into the hose 616b, while another electronically controllable valve 645b (see FIG. 17) located nearer the liquid pump 617 controls liquid flow into the hose 616b. In this manner, high-pressure liquid, high-pressure gas or both high-pressure liquid and high-pressure gas may be provided to the nozzle 614b at the end of the hose 616b. When the detachable lance 614b is released from the end effector 613 and the boom 605 is redeployed, the hose reel 622b rotates as the hose 616b unwinds from the reel 622b. Each of the hose reels on the trailer may be mounted and configured in a similar manner.

With particular reference to FIG. 12A and FIG. 12B, the hose guide 624 attached to the first arm 625 of the boom 605 proximate a joint between the first arm 625 and the second arm 627 provides a point of releasable attachment for the hoses 616a, 616b, along the boom 605. A similar hose guide on the other side of the first arm 625 provides a point of releasable attachment for the hoses 616c, 616d. The hose guide 624 comprises a bracket 650 on which pulleys 646a, 646b are rotationally mounted on an outer surface thereof. The hoses 616a, 616b ride on the pulleys 646a, 646b, respectively. When the boom 605 is not being extended or retracted, the hoses 616a, 616b may be frictionally locked on the pulleys 646a, 646b by lock bars 647a, 647b, respectively, mounted to actuator rods 648a, 648b, respectively, of actuators 649a, 649b, respectively. The lock bars 647a, 647b are translatable within slots 651a, 651b, respectively, in the bracket 650. The actuators 649a, 649b are mounted on an inner surface of the bracket 650. A locked position is shown for the actuator 649a where the lock bar 647a is translated in the slot 651a toward the pulley 646a to hold the hose 616a against the pulley 646a. When the boom 605 is being extended or retracted, or when a hose is to be released upon release of a nozzle from the end effector, the hose must be unlocked. An unlocked position is shown for the actuator 649b where the lock bar 647b is translated in the slot 651b away from the pulley 646b to release the hose 616b on the pulley 646b. Operation of the actuators 649a, 649b may be controlled by the control system. Movement of the boom 605 allows the hoses 616a, 616b to be pulled free from the hose guide 624 when the lock bars 616a, 616b are in respective unlocked positions.

With particular reference to FIG. 13A, FIG. 13B, FIG. 13C and FIG. 13D, the end effector 613 may be mounted on the boom 605 at the distal end of the second arm 627. The end effector 613 comprises a holder 663, first and second hydraulically driven rotary gears 661, 662, respectively, at a proximal end of the holder 663 and a harpoon assembly bracket 664 at a distal end of the holder 663 configured to mount harpoon assemblies 700 (only one labeled as 700a), the harpoon assemblies 700 equipped with the detachable lances 614 (only one labeled as 614a). In the embodiment illustrated, the harpoon assembly bracket 664 has four harpoon assemblies 700 mounted thereon, although the harpoon assembly bracket may be configured to mount one or a plurality of harpoon assemblies, for example one, two, three, four, five, six or more harpoon assemblies.

The first rotary gear 661 is rotatably mounted on the second arm 627 of the boom 605; the second rotary gear 662 is rotatably mounted on the first rotary gear 661; the holder is fixedly mounted on the second rotary gear 662; and, the harpoon assembly bracket 664 is slidably mounted on the holder 663. The first and second rotary gears 661, 662 rotate in substantially orthogonal planes both of which are substantially orthogonal to the ground. The first rotary gear 661 rotates in a plane substantially parallel to a longitudinal axis of the end effector 613 and the second rotary gear 662 rotates in a plane substantially perpendicular to the longitudinal axis of the end effector 613. Rotation of both the first and second rotary gears 661, 662 is accomplished by hydraulic motors in the gears, the hydraulic motors receiving hydraulic fluid through hydraulic lines from a hydraulic fluid supply located in the housing of the trailer. Rotation of the first rotary gear 661 causes the end effector 613 to move through an arc in a vertical plane with respect to the ground (compare FIG. 13B, FIG. 13C and FIG. 13D). Such motion coupled with vertical motion of the boom 605 contributes to the driving force required to permit the detachable lances 614 to pierce a structure, for example the roof 591 of the building 590 illustrated in FIG. 1. When piercing a structure, it is important to maintain orientation of the detachable lance in the same direction during the piercing operation to avoid damaging the detachable lance and/or jamming the detachable lance in the structure. In order to keep the detachable lances 614 oriented in the same direction while the end effector 613 moves in an arc during a piercing operation, the harpoon assembly bracket 664 is slidably mounted on the holder 663 and the harpoon assemblies 700 are rotatably mounted on the harpoon assembly bracket 664. As the end effector 613 moves in an arc, the harpoon assembly bracket 664 may be retracted or extended in relation to the distal end of the holder 663 and the relevant harpoon assembly 700 (see FIG. 13B, FIG. 13C and FIG. 13D) is rotated to keep the relevant detachable lance 614 pointing the same direction.

Retraction and extension of the harpoon assembly bracket 664 may be accomplished by a head alignment controller 670 fixedly mounted on an inner wall of the holder 663, which may be a hollow tube. The head alignment controller 670 may comprise an extendible actuator (e.g. a hydraulic cylinder or a linear actuator) having an actuator rod 671 and a body 672. The harpoon assembly bracket 664 may be mounted on the body 672 and the actuator rod 671 mounted in the holder 663 (or vice versa). Extension and retraction of the actuator rod 671 causes the harpoon assembly bracket 664 to slide. How the harpoon assemblies 700 are rotatably mounted on the harpoon assembly bracket 664 is described in more detail below. All motions may be controlled and coordinated by the control system to ensure proper operation.

Rotation of the second rotary gear 662 permits rotating the end effector 613 around the longitudinal axis of the end effector 613. After one of the detachable lances 614 has been deployed, the end effector 613 may be rotated by action of the second rotary gear 662 to rotate the harpoon assembly bracket 664 to index the next harpoon assembly into a proper position to deploy the next detachable nozzle. Because there are four harpoon assemblies 700 in the illustrated embodiment, the end effector is rotated through 90° in each indexing step, although a different number of harpoon assemblies would change the amount of rotation needed to properly position the next harpoon assembly. However, hydraulic lines 669 are routed from the second arm 627 of the boom 605 through the holder 663 to supply hydraulic fluid to hydraulic components in the harpoon assemblies 700. To ensure that the hydraulic lines 669 are not twisted during rotation of the second rotary gear 662, a hydraulic port connector 667 with a quick connect coupler 668 are employed. The hydraulic port connector 667 comprises a first half 667a mounted on a portion of the end effector that does not rotate when the second rotary gear 662 rotates, and a second half 667b mounted in the holder 663, the second half 667b rotating with the holder 663 as the second rotary gear 662 rotates. The quick connect coupler 668 comprises an actuator (e.g. a hydraulic cylinder or a linear actuator) attached to a collar on the first half 667a of the quick connect coupler 668, the actuator retracting to move the first half 667a away from the second half 667b just before rotation of the second rotary gear 662 thereby breaking a seal between the two halves 667a, 667b, and extends the first half 667a back to the second half 667b just after the rotation of the second rotary gear 662 thereby reforming the seal between the two halves 667a, 667b. The ports on the two halves 667a, 667b are symmetrically arranged so that the port configuration is symmetrically invariant throughout all of the required rotations and the ports on the two halves 667a, 667b are always aligned after each rotation.

With particular reference to FIG. 14A, FIG. 14B, FIG. 14C, FIG. 14D and FIG. 14E, the end effector 613 comprises four harpoon assemblies 700 (labeled individually as 700a, 700b, 700c, 700d), the harpoon assemblies 700 comprising the detachable lances 614a, 614b, 614c, 614d (only three labeled), respectively. The harpoon assemblies 700 are pivotally mounted on the harpoon assembly bracket 664. The harpoon assembly bracket 664 comprises four L-flanges 674 (individually labeled in FIG. 14A as 674a, 674b, 674c, 674d), each L-flange 674 formed integrally with or otherwise secured to the harpoon assembly bracket 664, for example by welding. Each L-flange 674 is orthogonally oriented with respect to a neighboring L-flange, and the L-flanges 674 form pockets in the harpoon assembly bracket 664 in which the harpoon assemblies 700 are mounted. The harpoon assemblies 700 are pivotally mounted in the pockets of the harpoon assembly bracket 664 on pivot pins 675 (only one labeled) through the L-flanges 674, and on hydraulic slew drives 705 (only two shown and labeled as 705b and 705c in FIG. 14E) mounted between the harpoon assemblies 700 and the harpoon assembly bracket 664 on opposite sides of each of the harpoon assemblies 700 as the respective pivot pins 675. The pivot pins 675 may comprise unthreaded or threaded pins, for example bolts, screws, rivets and the like. The L-flanges 674 are annularly distributed around a perimeter of the holder 663 so that the harpoon assemblies 700 are also annularly distributed around the perimeter of the holder 663.

In a stowed position, as seen in FIG. 14A, FIG. 14B and FIG. 14C, the detachable lances 614a, 614b, 614c, 614d are oriented parallel to the longitudinal axis of the end effector 613 and each of the detachable lances is 614a, 614b, 614c, 614d situated alongside the holder 663. As seen in FIG. 14D, to deploy one of the detachable lances 614b for penetration into a structure, the harpoon assembly 700b is rotated into an operating position. In the operating position, a longitudinal axis of the detachable lance 614b can be in any suitable orientation with respect to the longitudinal axis of the end effector 613, including pointing straight away from the distal end of the end effector 613 (i.e. rotated 180° from the stowed position). In FIG. 14D, the deployed detachable lance 614b forms an angle of about 90° with the end effector 613. Other angles are shown in FIG. 13B and FIG. 13D. The harpoon assembly 700b may be rotated as much as 270° from the stowed position. The slew drive 705b (see FIG. 14E) is operated to rotate the detachable lance 614b to the desired orientation. Because the boom and the first rotary gear are employed as motive forces to help the detachable lance pierce the structure, the detachable lance chosen for deployment is one which will point generally in the correct direction for the boom and first rotary gear to be effective in moving the detachable lance to pierce the structure. The direction could be any direction depending on the orientation of the boom, first rotary gear and the structure to be pierced.

With particular reference to FIG. 15, FIG. 16A and FIG. 16B, the harpoon assembly 700 comprises a head 701, which is pivotally mounted to the harpoon assembly bracket 664 by the pivot pin 675 mounted through an aperture 702 on one side of the head 701 and by the slew drive 705 on an opposite of the head 701. The detachable lance 614 is releasably connected to the head 701 at a connection lug 706 situated within the head 701 proximate a distal end of the head 701. The connection lug 706 comprises a jaw 708 having a plurality of pivoting jaw elements 709 (only one labeled) that engage the detachable lance 614 to hold the detachable lance 614 on the harpoon assembly 700. A proximal end of the detachable lance 614 comprises an annular rim 707 (see FIG. 16B) that extends radially from a shaft 714 of the detachable lance 614 and provides a protruding surface on to which the pivoting jaw elements 709 of the jaw 708 may clamp to hold the proximal end of the detachable lance 614 in the connection lug 706.

The jaw 708 is mounted on a slide rail 710, the slide rail 710 slidingly mounted in the head 701. The slide rail 710 comprises an L-bracket having a transversely-oriented plate 710b attached to a longitudinally oriented plate 710a. The jaw 708 depends longitudinally from the transversely-oriented plate 710b towards the distal end of the head 701. The longitudinally oriented plate 710a is slidingly mounted on a track 713 secured to an inner wall of the head 701. The longitudinally oriented plate 710a is also connected to a longitudinally translatable rod 711, which is driven by a hydraulic slide rail motor 712 mounted on an inner wall of the head 701. Operation of the slide rail motor 712 extends and retracts the translatable rod 711, which translates the slide rail 710 longitudinally along the track 713. Translation of the slide rail 710 proximally within the head 701 causes the jaw elements 709 of the jaw 708 to pivot into an open configuration, which releases the annular rim 707 of the detachable lance 614 permitting the detachable lance 614 to separate from the head 701, as shown in FIG. 16B. Pressure of the pressurized fluid in the detachable lance 614 helps separate the detachable lance 614 from the head 701 more quickly and cleanly. The detachable lance 614 may be reattached to the head 701 by inserting the annular rim 707 into the connection lug 706 and translating the slide rail 710 distally in the head 701 thereby causing the jaw elements 709 of the jaw 708 to pivot to a closed configuration thus clamping the annular rim 707 of the detachable lance 614.

The head 701 also contains a hydraulic drill motor 715 mounted on a proximally facing surface of the transversely-oriented plate 710b with a drive shaft of the drill motor 715 extending through an aperture in the transversely-oriented plate 710b to be attached to the jaw 708. Thus, the jaw 708 is mounted on the drive shaft of the drill motor 715 whilst depending distally toward the distal end of the head 701. Operation of the drill motor 715 rotates the jaw 708 about a longitudinally oriented rotation axis, which rotates the detachable lance 614 secured in the jaw 708. The detachable lance 614 is provided with a tapered drill bit 720 at a distal end of the detachable lance 614, which assists with penetrating a structure as the drill motor 715 rotates the detachable lance 614 to drill through the structure, while simultaneously the boom 605 and the first rotary gear 661 provide force to punch the detachable lance 614 through the structure.

The detachable lance 614 comprises a hose connection 725 situated proximate the proximal end of the detachable lance 614. The hose connection 725 comprises a fluid flow conduit 726 mounted in a collar 727, the fluid flow conduit 726 in fluid communication with the hose 616 and in fluid communication with a hollow interior of the detachable lance 614. The collar 727 is annularly disposed around the 714 of the detachable lance 614 to mount the detachable lance 614 therein, with the fluid flow conduit 726 extending transversely from the collar 727. The collar 727 comprises a bearing therein so that the detachable lance 614 can rotate within the collar 727 during a drilling operation. To further prevent rotation of the hose connection 725 during a drilling operation, the harpoon assembly 700 comprises a rotational lock 729 rigidly mounted on and depending distally from the distal end of the head 701. The rotational lock 729 comprises spaced apart flanges forming a notch in which the fluid flow conduit 726 is situated when the detachable lance 614 is attached to the head 701. The spaced apart flanges provide stops for the fluid flow conduit 726 in a rotational plane thereby preventing the hose connection 725 from rotating with the detachable lance 614. Spring-loaded stops 717 (only one labeled) extending radially from the shaft 714 of the detachable lance 614 and situated distally of the hose connection 725 permit passage of the detachable lance 614 through the small hole in the structure created by the detachable lance 614 because the springs therein compress as the radially extending stops 717 pass through the hole. However, the detachable lance 614 is prevented from backing out of the structure because abutment surfaces 718 (only one labeled) of the stops abut the structure preventing further backward movement of the detachable lance 614 once the detachable lance 614 has pierced the structure and has been lodged therein.

The slew drive 705, hydraulic drill motor 715 and slide rail motor 712 are hydraulically powered. Thus, six hydraulic fluid lines are required for each of the harpoon assemblies 700. With four the harpoon assemblies 700 mounted on the harpoon assembly bracket 664, a total of twenty-four hydraulic lines must reach past the second rotary gear 662 to power the hydraulic components of the end effector 613. Therefore, the hydraulic lines 669 routed from the second arm 627 of the boom 605 through the holder 663 to supply hydraulic fluid to the hydraulic components in the harpoon assemblies 700 are twenty-four in number.

The shaft 714 of the detachable lance 614 comprises a hollow tube that receives fluid (e.g. liquid, gas or both liquid and gas) from the fluid flow conduit 726 attached to the hose 616. The fluid passes through the shaft 714 under pressure to exit the shaft 714 through a plurality of outlet apertures 730 (only one labeled) on a side of the shaft 714 proximate the distal end of the detachable lance 614. The outlets may be transversely or obliquely oriented to direct the fluid laterally and/or longitudinally as the fluid exits the outlet apertures 730. The apertures 730 may be sized and configured to aerosolize any liquid being sprayed out of the detachable lance 614.

The harpoon assembly 700 may be equipped with various communication sensors and other devices that may assist in fighting a fire. For example, the head 701 may comprise an inclinometer 732 that senses the angle at which the harpoon assembly 700 points with respect to the ground. When transmitted to the control system, either wirelessly or through a wired connection) such information can be processed to assist in determining whether the harpoon assembly 700 is properly angled for the detachable lance 614 to penetrate the structure. Further, a high temperature thermocouple 734 and/or other sensors (e.g. a sound sensor) may be embedded in the detachable lance 614 proximate the distal end of the detachable lance 614. The thermocouple 734 measures temperature in the area around the detachable lance 614. Temperature information may be transmitted to the control system to assist in determining whether the fire has been extinguished in that area and for determining how to control the flow of fluid to the detachable lance 614. The thermocouple 734 permits this determination even though the area around the detachable lance 614 is in the structure and may not be visible to either the operator or to thermal imaging cameras mounted on the end effector 613 or boom 605 outside the structure. Such information is valuable for conserving fluids, which is important in all instances, but imperative when the fire is in a remote location where access to fluid supply is limited. Data from the thermocouple 734 may be transmitted wirelessly or by wired connection. For example, a fluid-proof communication line 736 electrically connected to the thermocouple 734 may be routed through the hollow shaft 714 of the detachable lance 614, out through the fluid flow conduit 726 all the way back through the hose 616 to the logic controller 620 on the housing 612 of the trailer 600. The various information from the sensors may be utilized by the operator to control the various functions, or intelligent control by a programmed logic circuit in the logic controller 620 may control the various functions in the context of pre-programmed parameters.

With particular reference to FIG. 17, fluid connections on the trailer 600 are illustrated. A single liquid tank 603 is in fluid communication with all of the nozzles 614, including the four detachable lances 614a, 614b, 614c, 614d and the fixed nozzle 614e through a common high-pressure liquid line 652. The liquid pump 617 situated between the liquid tank 603 and the nozzles 614 draws liquid from the liquid tank 603 through the low-pressure liquid line 631, and pumps the liquid under pressure into the common high-pressure liquid line 652. The common high-pressure liquid line 652 splits into individual high-pressure liquid lines 640a, 640b, 640c, 640d to ultimately provide liquid to the detachable lances 614a, 614b, 614c, 614d, respectively. Flow of liquid from the common high-pressure liquid line 652 into the individual high-pressure liquid lines 640a, 640b, 640c, 640d is controlled by individual electronically controllable valves 645a, 645b, 645c, 645d, respectively, which are independently controllable by the control system. The hose 616e to the fixed nozzle 614e is directly tied to the common high-pressure liquid line 652 with an electronically controllable valve 645e between the hose 616e and the common high-pressure liquid line 652, the electronically controllable valve 645e also independently controllable by the control system. Gas tanks 618 (individually labeled as 618a, 618b, 618c, 618d) containing pressurized inert gas provide the gas to the respective detachable lances 614a, 614b, 614c, 614d via respective high-pressure gas lines 641a, 641b, 641c, 641d. Valves 644a, 644b, 644c, 644d, also independently controllable by the control system, on the respective high-pressure gas lines 641a, 641b, 641c, 641d control flow of the gas out of the gas tanks 618a, 618b, 618c, 618d. The individual high-pressure liquid lines 640a, 640b, 640c, 640d and the individual high-pressure gas lines 641a, 641b, 641c, 641d are joined together to form single high-pressure fluid lines 643a, 643b, 643c, 643d, respectively, which carry fluid (the liquid, the inert gas or both the liquid and the inert gas) to the respective hoses 616a, 616b, 616c, 616d wound on the respective hose reels 622a, 622b, 622c, 622d. By selectively controlling the valves 644a, 644b, 644c, 644d, 645a, 645b, 645c, 645d any given hose 616a, 616b, 616c, 616d, and therefore any given detachable lance 614a, 614b, 614c, 614d, may be supplied only with the liquid, only with the inert gas or with the inert gas entrained in the liquid.

The fluid connections illustrated in FIG. 17 provide versatility when fighting a fire. The different types of fluid permit extinguishing different classes of fires, and permit a staged approach to fighting a fire in which inert gas may be sprayed first to smother the fire and put out the flames, followed by spraying liquid to cool the hot spot so that the fire does not reignite. In some cases, there may be a need to spray both the inert gas and the liquid simultaneously to both smother and cool the fire at the same time. Coupled with information provided by the thermocouples 734 and the other sensors (e.g. thermal imaging cameras), individual control of the valves 644a, 644b, 644c, 644d, 645a, 645b, 645c, 645d, 645e (collectively 644, 645) permits shutting of fluid flow (liquid and/or gas flow) to any given nozzle 614a, 614b, 614c, 614d, 614e when conditions in an area around the given nozzle no longer require the application of fluid. In addition, should conditions change at the given nozzle to which fluid flow has previously been stopped, fluid flow may be readily restarted to the given nozzle. Such control may be performed by an operator, or by an intelligent logic programmed into a logic controller of the control system. Fluid management is thus made easier, and fluid conservation may be maximized to provide more effective firefighting capability.

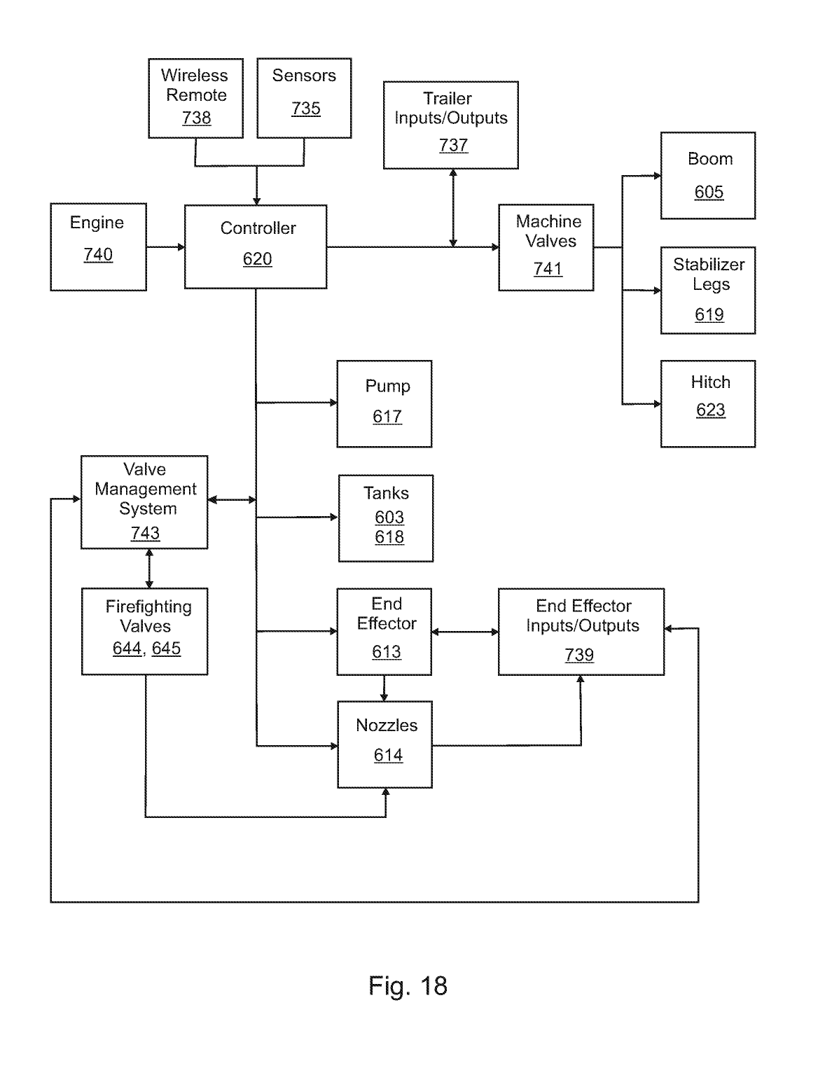

With reference to FIG. 18, the trailer 600, or any other embodiment of the trailer, may be provided with the controller 620 comprising circuitry programmed with machine logic that may synthesize data elements related to the status of the boom 605, stabilizer legs 619, hitch 623, pump 617 and end effector 613 and data obtained from various sensor 735, including the thermocouples 734 and the other sensors. The controller 620 may be controlled by and may provide information to the operator 745 by way of a trailer input/output device 737 and/or an end effector input/output device 739 associated with the controller 620. The controller 620 may also receive signals from the wireless remote control 738 instead of or in addition to the input/output devices 737, 739 to permit an operator to control function of the trailer 600 including the effector 613 from a remote location. The controller 620 may receive power from an engine 740 mounted on the trailer 600, the engine 740 powering the controller 620 as well as the operation of the boom 605, stabilizer legs 619, hitch 623, pump 617 and end effector 613. In some embodiments, the engine 740 may power one or more hydraulic pumps, which power one or more of the boom 605, stabilizer legs 619, hitch 623, pump 617 and end effector 613 through one or more hydraulic circuits involving hydraulic machine valves 741.

The controller 620 may comprise a logic circuit, for example a programmable logic circuit (PLC), which may comprise one or more microprocessors. The programmable logic circuit may be configured to automatically control one or more aspects of operation of the trailer 600. For example, the logic circuit may be configured to simultaneously and automatically unlock the boom 605, unlock and lower the stabilizer legs 619 and detach the hitch 623 from the towing vehicle when the engine 740 is switched on, or upon activation of a single control switch on the controller 620 or remote control 738. Simultaneous and automatic operation in this manner permits raising the boom 605 very quickly, for example within 30 seconds of arriving at a location, which is particularly useful in firefighting application where time is of the essence. In another example, the logic circuit may be configured to automatically increase or decrease fluid pressure and/or adjust the position and/or angle of the nozzles 614 based on information collected by the sensors 735.

Further, the logic circuit may be configured to control a valve management system 743, which manages the firefighting valves 644, 645 that control flow of fluid from the tanks 603, 618. The valve management system 743 controlled by the controller 620 permits effective fluid conservation based on information received from the sensors 735, as described above in connection with FIG. 17.

From the foregoing description, it can be seen that the various components of the trailer may undergo at least eight different motions to properly orient and deploy the nozzles in a variety of circumstances to effectively fight a fire. These motions include, for example, vertical movement of the boom, rotation of the boom in a horizontal plane, horizontal translation of the boom, vertical translation of the end effector, horizontal translation of the end effector, rotation of the end effector about the end effector's longitudinal axis, pivoting of the nozzles and rotation of the nozzles for drilling. Further, the trailer can be deployed to fight any type of fire (e.g. Class A, Class B, Class C, Class D, Class E and Class F fires) at multiple locations to more quickly extinguish the fires with the use of less fluid. The trailer can also be deployed for purposes other than firefighting, for example cleaning hard to reach structures. Such versatility is advantageous and surprising in a single apparatus designed to be operated by a single operator.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A flowable material delivery trailer comprising:
at least one frame;
an articulated boom rotatably mounted on the at least one frame proximate a first end of the boom;
at least one flowable material reservoir mounted on the at least one frame for containing at least one flowable material to be delivered;
a plurality of detachable flowable material delivery nozzles releasably mounted on the boom proximate a second end of the boom; and,
a plurality of flowable material lines in flow communication with the at least one flowable material reservoir and the detachable flowable material delivery nozzles, the detachable flowable material delivery nozzles operable independently and simultaneously to deliver the at least one flowable material.

2. The trailer according to claim 1, wherein the detachable flowable material delivery nozzles are configured to penetrate a structure and to be releasable from the boom after penetrating the structure.

3. The trailer according to claim 1, wherein the detachable flowable material delivery nozzles each comprise a hollow lance releasably attached to a head, the lance comprising a hollow interior and a flowable material inlet fluidly connecting the hollow interior to one of the plurality of flowable material lines, the lance further comprising at least one flowable material outlet out of which the at least one flowable material is sprayed, the lance together with the one of the plurality of flowable material lines releasable from the head while the head remains mounted on the boom.

4. The trailer according to claim 3, wherein the head is rotatably mounted on the boom, rotation of the head moving the lance between a stowed position and an operating position, the lance oriented to penetrate the structure when the lance is in the operating position.

5. The trailer according to claim 4, further comprising a holder rotatably mounted on the boom, each head rotatably mounted on the rotatable holder, rotation of the holder indexing a given head to a position where rotating the lance of given head to the operating position orients the lance to penetrate the structure.

6. The trailer according to claim 1, wherein the at least one flowable material reservoir comprises a common liquid reservoir containing a liquid and a plurality of inert gas tanks containing an inert gas, wherein all of the detachable flowable material delivery nozzles are in fluid communication with the common liquid reservoir and each of the detachable flowable material delivery nozzles is in fluid communication with one of the inert gas tanks.

7. The trailer according to claim 6, wherein the detachable flowable material delivery nozzles each has one of the plurality of flowable material lines in fluid communication therewith, wherein each one of the plurality of flowable material lines in fluid communication with the detachable flowable material delivery nozzles is in fluid communication with both the common liquid reservoir and one of the plurality of inert gas tanks to permit delivery of the liquid, the inert gas or both the liquid and inert gas through the detachable flowable material delivery nozzles.

8. The trailer according to claim 7, further comprising a plurality of flowable material line reels mounted on the trailer, and the plurality of flowable material lines in fluid communication with the detachable flowable material delivery nozzles are wound on the reels to permit unwinding of a given flowable material line when the boom is moved after deploying and releasing the detachable flowable material delivery nozzle in fluid communication with the given flowable material line.

9. The trailer according to claim 7, further comprising: a programmed logic circuit (PLC); a plurality of sensors in electronic communication with the PLC, each of the detachable flowable material delivery nozzles having at least one of the plurality of sensors mounted thereon; and a plurality of electronically controllable valves in the plurality of flowable material lines, wherein the PLC controls opening and closing of the valves in response to information from the plurality of sensors.

10. The trailer according to claim 1, wherein the flowable material comprises a fluid.

11. A flowable material delivery trailer comprising:
at least one frame;
a plurality of wheels mounted on the at least one frame for transporting the trailer between locations;
a plurality of outriggers mounted on the at least one frame, the outriggers moveable between a raised ground-disengaging position to permit the trailer to be transported on the plurality of wheels and a lowered ground-engaging position to stabilize the trailer on the ground and prevent the trailer from being transported on the plurality of wheels;
a hitch for attaching the trailer to a towing vehicle;
a flowable material reservoir for containing a flowable material to be delivered;
an articulated boom rotatably mounted on the at least one frame proximate a first end of the boom;
a hydraulically operated end effector mounted on the boom proximate a second end of the boom, the end effector comprising a flowable material delivery nozzle in fluid communication with the flowable material reservoir, the flowable material delivery nozzle operable to deliver the flowable material at a low flow rate and high pressure;
at least one pump operably connected to the flowable material reservoir and the nozzle for pumping the flowable material from the reservoir to the nozzle;
a control system configured to operate the at least one pump, outriggers, hitch, articulated boom and/or end effector, the control system comprising a logic circuit configured to compile information for use by a single operator; and,
at least one power source operably connected to the at least one pump, outriggers, hitch, articulated boom, end effector and/or control system for powering the pump, outriggers, articulated boom, end effector and/or control system.

12. The trailer according to claim 11, wherein the outriggers are adjustable in length, and height and reach limitations are applied to the boom depending on the length to which the outriggers are adjusted.

13. The trailer according to claim 11, wherein the flowable material comprises a fluid.

14. A method of conserving flowable firefighting material while fighting a fire in a structure, the method comprising:
determining a first location of a first hot spot inside a burning structure indicative of a fire burning at the first location;
deploying a first spray nozzle in or proximate to the first hot spot by penetrating the structure with the first nozzle so that at least a portion of the first nozzle is inside the structure, and switching on a flow of a first flowable firefighting material to the first nozzle;
sensing a first characteristic of the fire at the first hot spot with a first sensor configured to determine, based on the first characteristic, whether the fire still burns at the first hot spot, the first sensor situated at the portion of the first nozzle inside the structure;
determining a second location of a second hot spot inside a burning structure indicative of a fire burning at the second location;
deploying a second spray nozzle in or proximate to the second hot spot by penetrating the structure with the second nozzle so that at least a portion of the second nozzle is inside the structure, and switching on a flow of a second flowable firefighting material to the second nozzle;
sensing a second characteristic of the fire at the second hot spot with a second sensor configured to determine, based on the second characteristic, whether the fire still burns at the second hot spot, the second sensor situated at the portion of the second nozzle inside the structure;
switching off the flow of the first flowable firefighting material to the first nozzle when the first sensor determines that the fire has stopped burning at the first location, or switching on the flow of the first flowable firefighting material to the first nozzle when the first sensor determines that the fire has restarted burning at the first location; and,
switching off the flow of the second flowable firefighting material to the second nozzle when the second sensor determines that the fire has stopped burning at the second location, or switching on the flow of second flowable firefighting material to the second nozzle when the second sensor determines that the fire has restarted burning at the second location.

15. The method according to claim 14, wherein the first and second sensors are temperature sensors.

16. The method according to claim 14, wherein the first and second flowable firefighting materials comprise a liquid and/or an inert gas, the first and second nozzles are in fluid communication with a common liquid reservoir containing the liquid and the first and second nozzles are in fluid communication with one or more inert gas tanks containing the inert gas, wherein flows of the liquid and the inert gas to the first and second nozzles are selectively controllable by operation of valves so that the first and second nozzles independently receive the liquid, inert gas or both liquid and inert gas in order to fight the fire at the first and/or second locations.

17. The method according to claim 16, wherein the flows of the liquid and the inert gas are selectively controlled by a programmed logic circuit in electronic communication with the first and second sensors and the valves, the programmed logic circuit configured to open and close the valves in response to signals from the first and second sensors indicating whether the fire is still burning at the first and second locations.

18. The method according to claim 16, wherein first and second nozzles are releasably attached to a boom movably mounted on a trailer, the first nozzle is deployed from the boom into the structure at the first location where the first nozzle is released from the boom, the boom is moved to the second location, and the second nozzle is deployed from the boom into the structure at the second location where the second nozzle is released from the boom.
